(19) United States
(12) Patent Application Publication
(10) Pub. No.: US 2018/0307245 A1
(43) Pub. Date: Oct. 25, 2018

(54) Autonomous Vehicle Corridor

(71) Applicants: Muhammad Zain Khawaja, Milton Keynes (GB); Sabdezar Ilahi, Milton Keynes (GB)

(72) Inventors: Muhammad Zain Khawaja, Milton Keynes (GB); Sabdezar Ilahi, Milton Keynes (GB)

(21) Appl. No.: 15/993,529

(22) Filed: May 30, 2018

Related U.S. Application Data
(60) Provisional application No. 62/512,915, filed on May 31, 2017.

(51) Int. Cl. G05D 1/02; G05D 1/00

(52) U.S. Cl. CPC G05D 1/0276; G05D 1/0022; G05D 1/0212

(57) ABSTRACT

System and methods are provided for creating perception-based intelligence for augmenting the on-board capabilities of autonomous vehicles and for coordinating the traffic flow of connected-autonomous vehicles. Perception-based intelligence is created on the basis of leveraging the perception outputs of, one or more vision-perception sensors in various locations, while having a field-of-view, or a range-of-perception-sensing, of a pre-determined physical space. Perception-based intelligence is made shareable, in a shared coordinate-frame. Various methods are disclosed for encoding and representing the locations coordinates of perception outputs relating to transient, obstacles and any free-space, such that these encoded outputs, could be efficiently provisioned to various types of connected-autonomous vehicles, either directly or through an intelligent transport system. Systems and methods are disclosed for creating perception-based enablements, such as; look-ahead and non-line-of-sight perception, planned obstacle avoidance ahead of approach, autonomous-traffic flow coordination, autonomous-manoeuvre safety guidance, zone entry permissions and priorities for use-of-space or right-of-passage.

### BACKGROUND

### Technical Field

The present disclosure relates generally to a system and methods, for creating perception-based intelligence for enabling safe autonomous navigation manoeuvres, as well as for coordinating road interaction among various types of connected-autonomous vehicles as well as manually driven connected-vehicles, within the context of any pre-determined physical space. Specifically, this disclosure teaches how such perception-based intelligence can be created, by utilising and leveraging perception outputs, of multiple vision-perception sensors, while these may be having a line-of-sight and field-of-view, or range-of-perception-sensing, of the pre-determined physical space. Additionally, this disclosure provides systems and methods, for variously encoding and representing the location coordinates of, transient, obstacles and free-space, being detected within the pre-determined physical space, in terms of a shareable coordinate-frame and variously creating different types of perception-based enablements, and therein, the perception outputs as well as the perception-based enablements being efficiently encoded as perception-based notifications, for augmenting various on-board capabilities of connected-autonomous vehicles, and the perception-based notifications being either directly communicated to connected-autonomous vehicles or being communicated through an intelligent transport system.

### Background Information

As autonomous vehicles of various capabilities, begin to move from the domain of research laboratories onto our road networks, it becomes logical that existing technical paradigms applied to transport infrastructure in the past, may need to rapidly evolve and transform, in order to; enable, support and coordinate, efficient, scalable and safe autonomous mobility, even amidst manually driven vehicles. It is envisaged that in the near future, many more, different types of connected-autonomous vehicles may be operating upon the road networks at various different levels of autonomous operation, and some example of these connected-autonomous vehicles may include; driverless cars with high speed travel capability, low-speed personal autonomous pods operating in mixed indoor-outdoor use cases, urban transport pods and shuttles operating in a shared mobility context, delivery vehicles that may be road vehicles or that are aerial drones or side-walk traversing ground vehicles, autonomously operating droids, aerial passenger drones, and even interchangeable aerial-ground delivery or passenger vehicles. In this milieu, as driverless cars begin to enter the market, and as the level of autonomous features of manually driven road vehicles also increases through the introduction of various types of advanced driver assist systems (ADAS), it is not apparent how transport infrastructure is likely to transform or evolve in order to address the transformative context of modern transport especially as related to automated driving systems.

Autonomous vehicle programs globally, are developing autonomous vehicles that are heavily reliant on various types of multiple, on-board vision-perception sensors such as; LIDARs, RADARs, stereo cameras, monocular cameras, and several others types of cameras and machine-vision sensors that have various different capabilities and limitations. In any case, any vision-perception sensor, is always subject to some inherent limitations of range-of-perception sensing, as well as, suffers from some type of field-of-view limitations. This naturally means that an autonomous vehicle may have to employ multiple on-board vision-perception sensors, being mounted at different locations upon the autonomous vehicle. Despite having any complex configuration of vision-perception sensors being on-board an autonomous vehicle, given the complex road configurations especially in dense urban areas, and in the presence of other larger vehicles such as buses and trucks, there can still be occlusions-of-view from the perspective of an autonomous vehicle. Similarly, trees and other foliage can result in occlusions-of-view. Further, there are many road configurations where for example, a bend in the road results in a ‘blind-turn’ and even for human drivers, a convex safety mirror may have been mounted alongside the bend, to provide visual information to the human drivers for safely navigating through a ‘blind-turn’. Similarly, on road networks built upon a hilly terrain, where the slope angle of the road, in terms of steepness of ascent or descent, is high, on-board vision-perception sensors of an autonomous vehicle could still lose the line-of-sight from time to time as the autonomous vehicle itself moves up and down.

It is not apparent today how Intelligent Transport Systems (ITS) could evolve in the future, to assist autonomous vehicles in overcoming the sensing and perception challenges related to autonomous driving and also how it could be made possible for an ITS to go beyond the current paradigm; one that currently seeks to deliver enhanced functionality to manually driven connected-vehicles, towards a new paradigm; offering enhanced functionality to various types of connected-autonomous vehicles operating at various different levels of autonomous operation, amidst manually driven vehicles. This latter challenge is especially immense in the context of multiple, different performance envelopes associated with; different types of connected-autonomous vehicles, different levels of vehicle autonomy, different operating speeds of connected-autonomous vehicles, different required safety envelopes, different sensor configurations (resulting in different line-of-sight and different field-of-view limitations), and different underlying software design approaches that interoperate with various machine-learning and artificial intelligence algorithms within an autonomous vehicle's software stack, for performing various types of on-board vision-perception tasks.

The current, underlying paradigm, even of today's Cooperative Intelligent Transport Systems (C-ITS), is to aggregate and transmit a range of status-based notifications and event-based notifications to facilitate human drivers who are using connected-vehicles, by employing a mass connected network. For example, De-centralised Environmental Notification Messages (‘DENMs’), which are event-triggered messages, may be broadcasted, to alert drivers of connected-vehicles that a hazardous event has taken place ahead. Cooperative Awareness Messages (‘CAMs’), which are a kind of heartbeat message, are messages that are periodically broadcasted by a connected-vehicle to its neighbours as a type of a proximity indicator. The main goals of such C-ITS, are to optimise journey time and to reduce congestion. Other types of messages, such as a Green Light Optimal Speed Advisory (GLOSA), would allow a driver of a connected-vehicle to (manually) modulate his vehicle's speed of approach towards a traffic light in order to arrive at the traffic light when it will be Green. Other crowd-sourced, navigation information services, for example ‘WAZE’, have the goal of assisting in reducing congestion, for example, by providing early warning to drivers about the level of route congestion along an intended route, and this is an example of an information service aggregated through human drivers for other human drivers. In other similar concepts, for example through beacons that enable a ‘Here I am’ message, vulnerable road users could transmit their proximity, for alerting nearby drivers of connected-vehicles, of the proximal presence of the vulnerable road user. Therefore, the contextual paradigm and communication functionality offered by a C-ITS does very little to resolve the challenges pertaining to automated driving systems or coordinating autonomous-vehicle traffic.

Some devices, such as automatic number plate recognition ‘ANPR’ cameras rely on optical character recognition technology for reading the number plates of vehicles and such types of cameras are used for law enforcement purposes. Other applications of cameras upon the road infrastructure, relate to closed circuit television ‘CCTV’ cameras being used in surveillance. In road surveillance CCTV applications, a video signal is transmitted to a set of monitors where the surveillance video can be viewed, allowing a human operator to intervene or call in an intervention. These applications also do not address the challenge in any way.

### BRIEF SUMMARY

In general, in an aspect, autonomous-vehicle navigation requires that an autonomous vehicle should be able to establish its own location context within its operating environment and this can be referred to as localisation.

In an aspect, it is possible that an autonomous vehicle may perform a manually-driven run upon a certain route and record its own odometry, through recording wheel odometry measurements for example or through recording visual odometry or even through fusing two or more odometry approaches, and thereby recording in its memory, a trace of the path it has taken. The autonomous vehicle can then attempt to drive over the same route autonomously and expect to retrace its previously driven path. However, gradually, as the autonomous vehicle performs the autonomous run upon the same route, the autonomous vehicle would undergo a slight drift between the current path trace in autonomous mode and the previous path trace in manually driven mode, and this drift may be referred to as odometry drift. For longer and longer paths, the odometry drift may accumulate more and more and it is considered that some external reference cue of the environment can be used to course-correct the autonomous vehicle upon the previous path by correcting for the amount of odometry drift it may have undergone.

In an aspect, this can be achieved by using the location of some landmark features previously perceived within the environment as a reference cue, and when perceiving the same landmark feature again, then performing a course correction, and achieving a course-correction on that basis. Dense three-dimensional maps and in some cases, even high-definition three-dimensional maps may be used to obtain multiple reference cues of features that could be observed in the environment. In some cases, it is possible that the autonomous vehicle may have performed a manually-driven, pre-mapping run itself in order to generate this type of map data or in other cases, the autonomous vehicle may utilise map data developed and provided by a third party map provider. Without the map data being available, the autonomous vehicle faces tremendous challenges in achieving localisation within its operating context.

While providing a localisation support to the autonomous vehicle, any of these types of three-dimensional maps, high definition maps, and even some slightly more ‘sparse’ versions of such maps, could be additionally providing an indication of the road edges, the curbs, lane markings and the location of traffic signals etcetera, within the autonomous vehicle's operating environment. In an aspect, these additional enablements, when available, allow the autonomous vehicle to then, not only localise within its context but also have the informed knowledge through the maps, pertaining to the location of such permanent road features along its road. Hence, this additional knowledge, being made available, as annotations within the maps, provides a type of a perception level redundancy to the autonomous vehicle's own on-board vision-perception sensors. However, this perception redundancy, insofar as the maps are concerned, only relates to the permanent or non-transient type of road features along the autonomous vehicle's path. The autonomous vehicle's on-board sensors still remain directly tasked to sense and perceive its operating environment for detecting all of the transient, obstacles that may occur along its route.

In an aspect it can be said therefore that even when operating in the context of a well annotated and updated localisation map, that additionally provides annotations pertaining to the permanent structures upon or along the road, as a perception redundancy, still the maps provide no perception redundancy whatsoever, in relation to transient, obstacles along or upon the path of the autonomous vehicle. Thus the entire burden of detecting, locating and avoiding any transient, obstacle along its path, which may be any type of an emergent obstacle, appearing unexpectedly upon the road, is a challenge that the autonomous vehicle's on-board sensors may have to deal with on their own.

Even as relating to the ability of the maps to provide the perception redundancy relating to the permanent structures along or upon the road, this requires that the maps must be updated to reflect the current context. So for example, consider a route that has been mapped on a certain day and herein the map is then annotated to include the locations of curbs and centre islands for example. Then, consider that the following day, road repairs are determined to be undertaken by the road authorities somewhere upon the mapped portion of the road, and as a result, several temporary road blocks, including traffic cones and other barricades are temporarily situated upon a section of the road. An autonomous vehicle therein relying on the map data from the prior day could perhaps still find sufficient landmark features around the road to localise within its context using that map, however due to the transient roadworks and the transient/temporary structures, some of the annotations within the map could have become invalid. The autonomous vehicle would then be misinformed regarding the newly arisen temporary structures disrupting its foreknowledge of permanent structures upon the road as annotated within the map. In an aspect it is possible that the autonomous vehicle is able to detect the temporary road blockades and is even able to run a machine learning detector that helps it recognise some of the more commonly encountered types of construction-related equipment, some of the construction vehicles and even some traffic cones for example. However it is also likely that a certain type of barricade, or a temporary fence or any associated debris relating to the construction, may either not be detected or not be adequately classified using the machine learning detector. This type of situation poses a huge challenge for an autonomous vehicle to operate safely in this context, and in an aspect, till the map can be updated to reflect that new situation upon the same road, or till the road situation resolves to its original state, this challenge would persist for all autonomous vehicles traversing this road and using this map, and consequently many autonomous vehicles may not be able to operate upon this road, or therein operate safely upon this road due to the transient, emergent obstacles.

Next it must be considered that on certain roads, including roads that have a sharp bend, or a steep slope, or roads with very large, complex, junctions and intersections, it is possible that the line-of-sight may not be available to any of the on-board vision-perception sensors upon or within an autonomous vehicle simply because of the road geometry or road configuration. In some such situations, for example around a ‘blind corner’, a convex mirror often comes to the aid of the human driver, but the same facility may not function for the driverless autonomous vehicle, and the convex mirror may not enable sufficient visual information, to be robustly interpreted by the autonomous vehicle.

For complex junctions that are very large, and high speed traffic is travelling through the junction, for example at a large, multi-lane, and multi-access route roundabout, the line-of-sight limitation would greatly challenge an autonomous vehicle that is suffering a line-of-sight limitation in relation to some portions of the roundabout. While human drivers, based on their skill and experience, and often relying on eye contact as well as subtle hand gestures, sometimes communicate with other drivers and are even otherwise, generally able to tackle such types of complex junction traffic. However, this type of challenge has not yet been resolved for autonomous vehicles.

In other aspects, the vision-perception task is challenging in adverse weather as well, such as in snow, fog and heavy rain. Also in adverse light conditions, for example in the presence of glare, or in low light, navigation is very challenging for an autonomous vehicle. Under any of these adverse weather or adverse light situations, the problem of dealing with detection of other road users, especially vulnerable road users who are not detected robustly by the autonomous vehicle's on-board sensors, or not detected on a timely basis, can result in catastrophic outcomes. It has been seen, even in the context of autonomous vehicles utilising multiple on-board sensors, that in certain cases, a partially occluded pedestrian may have been undetected by an autonomous vehicle, especially during night-time autonomous driving, and especially if the pedestrian appears upon the road unexpectedly, or is found at an unexpected location upon the road that may not have been a designated pedestrian crossing known to the software system of the autonomous vehicle.

In addition to the above challenges, coordination of autonomous traffic amidst manually driven cars is also another challenge. An autonomous vehicle encountering a manually driven, un-connected vehicle at such a ‘blind-turn’ is not enabled to negotiate any entry or passage protocol with the manually driven vehicle, and would possess no safe mechanism for passing through such a ‘blind-turn’ in absence of line-of-sight.

The present invention tackles these challenges. As disclosed in various embodiments, enables perceiving and constantly updating the ever-changing situation of transient, obstacles within the context of any pre-determined physical space, through employing and leveraging the perception outputs of infrastructure-deployed vision-perception sensors; that either happen to be located such that these may be having an adequate line-of-sight of the scene within the pre-determined physical space, or that are specifically located for the purpose to have an adequate line-of-sight of the scene within the pre-determined physical space. Multiple vision-perception sensors may be utilised in relation to any pre-determined region.

Any location coordinates pertaining to any perception outputs, as being determined initially, would be in terms of the coordinate-frame-of-reference of the vision-perception sensor acquiring the perception feed. For these location coordinates to be utilised as a perception redundancy to the on-board vision-perception tasks, these location coordinates need to be made interpretable to the autonomous vehicle in relation to the autonomous vehicle's own location context. In an aspect, this could be a one-step process or it could be a two-step process.

In an aspect, as a one-step process, this could be achieved by cross referencing of the precise geo-location coordinates of an infrastructure-deployed vision-perception sensor and the geo-location coordinates of the autonomous vehicle at any instance of time and therein performing a coordinate-transform of any of the location coordinates being in terms of the vision-perception sensor into a coordinate-frame of the autonomous vehicle itself. This would be possible through direct communication between the autonomous vehicle and the infrastructure-deployed vision-perception sensor and could happen for example, through a transceiver being on-board the autonomous vehicle as well as a transceiver co-located with the infrastructure-deployed vision-perception sensor as well as both independently having highly precise global positioning system (GPS) location fixes at that instance of time. However, there would be several limitations applicable to this type of a one-step process scenario. Firstly, the autonomous vehicle would not be in a position to map the location coordinates precisely to the context of the any pre-determined physical space. This problem is further compounded, if the perception outputs of more than one vision-perception sensor are being utilised to achieve perception coverage of various parts of the scene therein as being within the pre-determined physical space. The autonomous vehicle would also not be able to map, the locations coordinates of the many various transient, obstacles being picked up from variously located vision-perception sensors looking upon different parts of the same pre-determined physical space, onto the whole of the pre-determined physical space and hence be unable to perceive the whole of the scene within the whole spatial context of the pre-determined physical space, in any meaningful and usable way. Accordingly therefore, the autonomous vehicle would not be in a position to dynamically track the location coordinates of any transient, moving obstacles within the pre-determined physical space, if as explained in this example, it had been suffering a line-of-sight limitation as well. Thus the one step process would be impractical and not even resolve the challenge herein posed, though technically, the coordinate-transforming would otherwise not be a challenge, given if, the communication and precise GPS enablements were to be in place.

On the other hand, a two-step process would entail, mapping the location coordinates, from the coordinate-frame-of-reference of the vision-perception sensors to the coordinate-frame-of-reference of the pre-determined physical space, and thereon with knowledge of the precise geo-location coordinates of the pre-determined physical space, knowledge of its dimensional scale, as well as any further cross-referenced annotations between the maps being used by an autonomous vehicle as well as any annotated landmark features within the pre-determined physical space, as a second step, a coordinate-transform of all of the location coordinates, from the coordinate-frame-of reference applicable to the physical context of pre-determined physical space, to the coordinate-frame-of-reference of the autonomous vehicle itself, could be performed. Under this two-step process scenario, using any number of multiple vision-perception sensors, therein, all location coordinates relating to the perception outputs from the various vision-perception sensors, covering various, different parts of the pre-determined physical space, can be aggregately mapped onto the context of the pre-determined physical space. The autonomous vehicle could effectively therein utilise the various time-referenced perception outputs, as all having been mapped to the coordinate-frame-of-reference of the pre-determined physical space, and this could serve as a shared coordinate-frame. Herein the enablement becoming available also to the autonomous vehicle, of not only comprehensively locating and tracking the dynamic motion of all transient, obstacles within the context of the pre-determined physical space, but it also becomes possible to create various types of autonomous traffic coordination enablements in the context of that pre-determined physical space. The system of the invention, utilising the location coordinates of various detections being mapped on to the context of the pre-determined physical space, could also generate various guidances for autonomous navigation manoeuvres; for entering, for stopping upon, or for passing through, any part of the pre-determined physical space, as well as generate, autonomous traffic coordination enablements for various types of connected-autonomous vehicles as well as manually driven connected-vehicles, and any of these guidances or enablements could be provisioned, as various perception-based notification files.

The various perception-based guidances and enablements, could be provisioned either directly to various types of connected-autonomous vehicles as well as to manually driven connected-vehicles, and alternatively, this could also be achieved via any other device or system intermediation, including through the communications and connectivity mechanisms of an ITS which could enable the sharing of many types of perception outputs, perception-based notifications, and various other coordination enablements, that are non-existent today even in the imminent context of automated driving systems of many kinds, becoming a reality. In all of these contexts, it becomes critical to consider the efficiencies that could be achieved by encoding the perception-based notification files in various ways in order to achieve a diverse set of efficient encoding mechanisms suitable under different circumstances. Accordingly, in various embodiments, different methods of variously encoding and representing the position-location coordinates of transient, obstacles being detected within a pre-determined physical space are presented.

In some embodiments, the possibility of offloading, any of the vision-perception tasks or component portions of other challenging tasks performed within an autonomous vehicle's software stack, from an autonomous vehicle's on-board systems to an infrastructure-deployed, perception-based, intelligent transport system (PB-ITS), one that incorporates perception-based intelligence into the context of an ITS, could create a system level perception redundancy contributing to higher levels of safety and efficiency for all connected-autonomous vehicles as well as for manually driven connected-vehicles. Leveraging perception-based intelligence, could help a connected-autonomous vehicle determine safe manoeuvres in advance of approaching an occluded part of the road or in advance of turning around a blind corner where visibility may not be available due to any limitations of the connected-autonomous vehicle's range-of-perception or field-of-view limitations and when there is no line-of-sight available even to a human driver, for example around a bend or a ‘blind-turn’. Leveraging perception-based intelligence also means, sharing perception outputs, and doing so, in a shared coordinate-frame, that is also shared, among various vision-perception sensors being either fixed or being upon any mobile platforms or vehicles.

The present invention, teaches how perception-based intelligence could be created for serving different types of connected-autonomous vehicles, operating at various levels of autonomous operation, either directly, or within the context of an ITS, and also how multiple autonomous vehicle enablements could be created on the same basis, to resolve the challenges faced in the scaled deployment and coordination of autonomous driving systems.

A total of 50, Claims are included.

A total of 21, Drawings are included. In the drawings, a set of dotted lines have been used. These have been used to illustrate some concepts that operate in a virtual context in relation to a physical space. The drawings have solid lines to refer to physical elements within the space, and accordingly, the dotted lines convey the ideas and illustrate the concepts that operate in the virtual context. In some drawings, coordinate labels are expressed through use of parentheses. It has been clarified in the accompanying descriptions to the drawings, how those coordinate labels are arrived at. In one drawing, FIG. 20, there are three lines which are composed of dot and dash. These three lines refer to a communication signal, however, no frequency or speed of communication is implied by this choice.

### Meaning of Terms

Throughout this disclosure, the following terms will have, the general meaning, as stated in this section. Any term, to which a general meaning is being ascribed herein for clarity, would have that general meaning, whether or not the term appears in the disclosure within any type of quotes, such as; within single quotes, or within double quotes, or without being surrounded by any type of quote. In the disclosure, a special, or a nuanced, or a modified meaning, can be ascribed to any of the terms whose general meaning is conveyed here. The general meaning of the term would apply regardless of whether the first alphabet of the term appears in the disclosure as being capitalised or not. Similarly, the general meaning of the term would apply regardless of whether the term appears in the disclosure as a singular expression or a plural expression, i.e. with or without an ‘s’ at the end.

Connected-autonomous vehicle: This term refers to any type of vehicle having at least, some level of automated driving capability and also having some level of connectivity enablement, and the connectivity enablement would mean, any or all of; an enablement for communication with other cars (and/or other types of vehicles), an enablement for communication with any component or system of an intelligent transport system, an enablement for communication with any roadside beacon, an enablement for communication with any type of remote sensors, an enablement for communication with any remote data server. An enablement for communication could be through any device or any mechanism and the enablement for communication could be one that is a constant enablement; all the time or everywhere, as well as an intermittent type of enablement for communication; some of the time and only in some communication coverage regions. A connected-autonomous car would be a type of a connected-autonomous vehicle. The automated driving capability of a connected-autonomous car could be defined as per the Society of Automotive Engineers' (SAE) definitions pertaining to levels of autonomy in driving systems. In the case of other types of connected-autonomous vehicles, such as; connected-autonomous aerial drones, connected-autonomous ground drones, connected-autonomous, connected-autonomous aerial and ground drones, etcetera, the level of autonomous motion capability (or level of automated driving capability) could be any level of capability, since the levels have not been formally defined. The term Connected-autonomous vehicle also includes within its meaning, that from time to time, a passenger riding within the connected-autonomous vehicle, or a remote operator, may be able to take over manual control of the connected-autonomous vehicle, and this does not violate the general meaning being ascribed to the term. In other circumstances, any type of connected-autonomous vehicle could be fully autonomous, similar to the definition concept of ‘Level-5’ as given by SAE definitions and applying to connected-autonomous cars and other connected-autonomous road vehicles.

Connected-vehicle: This term refers to any type of, manually driven or manually operated vehicle, having no automated driving capability but having some level of connectivity enablement, and the connectivity enablement would mean, any or all of; an enablement for communication with other cars (and/or other types of vehicles), an enablement for communication with any component or system of an intelligent transport system, an enablement for communication with any roadside beacon, an enablement for communication with any type of remote sensors, an enablement for communication with any remote data server. An enablement for communication could be through any device or any mechanism and the enablement for communication could be one that is a constant enablement; all the time or everywhere, as well as an intermittent type of enablement for communication; some of the time and only in some communication coverage regions.

Automated driving system: This term refers to any system composed of sensors and processors which are installed upon a vehicle to provide any level of automated driving.

Obstacle: This term refers to any object or structure, which any vehicle should not collide with. Also, it may be noted that one vehicle could be an obstacle from another vehicle's perspective.

Transient, obstacle: This term refers to any obstacle which is not a permanent structure upon a road (for example), or which is not permanent structure upon any designated-for-use pathway, over any specified observed window of time. Examples of a transient, obstacle include; a pedestrian, any type of vehicle, any type of drone, any type of physical item such as debris, or traffic cones, a fallen tree branch, etcetera. There are, further, three categories that fall within the meaning of this term. The first is; transient, static obstacle. The second is; transient, moving obstacle. The third is; transient, moving obstacle that may have come to be in a still state.

Transient, static obstacle: This term refers to a transient, obstacle that is detected as being in a still state or static state, over any specified observed window of time (‘still’ and ‘static’ being interchangeable terms).

Transient, moving obstacle: This term refers to a transient, obstacle that is detected as being in a state of motion, over any specified observed window of time. Ordinarily, the term ‘moving obstacle’ or ‘dynamic obstacle’ could interchangeably be used in the literature to mean the same thing as the term ‘transient, moving obstacle’.

Transient, moving obstacle that may have come to be in a still state: This term, refers to a transient, moving obstacle, that is detected as being in a still state, over any specified observed window of time, after, it had been detected as being in a state of motion during any earlier observed window of time.

Any transient, obstacle being in any state of motion or being static, as detected: In this phrase (or in any other phrases being evidently similar to this phrase), when used anywhere in the disclosure, the ‘any state’ would be any of the above three states, as can be inferred with reference to the states of the three defined categories within transient, obstacles.

Free-space: This term refers to any portion of a physical space, which does not contain an obstacle within in it or upon it, and within such a portion, being the free-space, any vehicle could operate. Accordingly, the term free-space means any portion of a physical space that is ‘free’ of all obstacles.

Vision-perception sensor: This term refers to any sensor that can acquire a perception feed of any type. Examples of vision-perception sensor include; stereo camera, LIDAR, RADAR, monocular camera, infrared camera, time-of-flight camera, any type stereo camera rig comprising two or more monocular cameras. In some cases, a vision-perception sensor would have conjoint functionality of two or more different types of vision-perception sensors listed above. The output of a vision-perception sensor could be the perception feed it acquires. By undertaking some processing through employing various algorithms, the perception feed from a vision-perception sensor can be converted to a processed, ‘perception output’. Some vision-perception sensors have the built-in technology capability for performing similar processing within their embedded processors using various proprietary algorithms, in various ways, and such vision-perception sensors produce a processed, ‘perception output’. Throughout this disclosure, the term perception output or the term perception outputs means, as described with reference to both types.

Perception outputs: This term means, as described with reference to the term ‘vision-perception sensor’. The format of the perception outputs from various types of vision-perception sensors would be different. For example, perception outputs may be in the format of pixel values for an image, or three-dimensional point values for a LIDAR scanner, or range, azimuthal angle, elevation angle, and velocity measurements for a RADAR. In the case of a stereo camera, the format would be a three-dimensional depth map values.

Grid occupancy map: In some places within this disclosure, this term refers to; a ‘two-dimensional, grid-representation’, when making a reference to a two-dimensional, perception-coverage region. In other places, within this disclosure, this term refers to a ‘three-dimensional, cuboid-representation’ when making a reference to a three-dimensional, perception-coverage region (and a three-dimensional, perception-coverage region is also interchangeably referred to as a perception zone).

Perception mast: This term refers to a structure or installation, upon which or within which, a vision-perception sensor and other supporting and interacting components, may be mounted and installed. (In the disclosure if a phrase reads for example; “from any 1010 to any other 1010”, it would mean “from any perception mast to any other perception mast”).

Pre-determined physical space: This term refers to a circumscribed part, of a physical space that is covered within a field-of-view of a vision-perception sensor. As referred to throughout the disclosure, the pre-determined physical space is always circumscribed in two dimensions of a ground plane.

Perception-coverage region: This term refers to; a region that may be established in correspondence to the exact footprint of any pre-determined physical space, or a region that may be established upon a portion of any pre-determined physical space. The perception-coverage region may be established as being a two-dimensional, perception-coverage region or as a three-dimensional, perception-coverage region. Accordingly a two-dimensional, ‘grid occupancy map’ could be constructed to represent the situational context of various, transient, obstacles within a two-dimensional, perception-coverage region. Similarly, a three-dimensional, ‘grid occupancy map’ could be constructed to represent the situational context of various, transient, obstacles within a three-dimensional, perception-coverage region. (It is important to note however, that a two-dimensional, ‘grid occupancy map’ could also be constructed to represent the situational context of various, transient, obstacles, two-dimensionally, even within a three-dimensional, perception-coverage region). A data representation scheme would be configured for any type of perception-coverage region. Also, a ‘level of resolution of data representation’, would therein be chosen. The disclosure details the concept of ‘level of resolution of data representation’.

Perception-zone: This term simply refers to, a three-dimensional, perception-coverage region.

### BRIEF DESCRIPTION OF DRAWINGS

FIG. 1 is a drawing showing a perspective view of a road segment, shown as a trapezoid bounded within four edge lines labelled; 101.3, 101.4, 101.5 and 101.6, and the road segment is within a geographic zone labelled 21. As a brief summary of some aspects, it can be said that FIG. 1 can be referenced for an explanation of the location context of any pre-determined physical space 101, being determined in relation to the road segment within the geographic zone, and also herein, with reference to FIG. 1, a reference vocabulary begins to be developed, to assist in variously teaching the system of the invention and the various methods as well.

FIG. 2 is a drawing showing a perspective view within the same geographic zone 21 (as shown in FIG. 1) and therein, as shown in this example, conforming to the exact footprint of 101, a perception zone, labelled 501, is shown to have been established, and 501 as shown, is representationally, in the shape of a cuboid, and has three distinct portions within it. As a brief summary of some aspects, it can be said that FIG. 2 can be referenced for an explanation of some additional reference vocabulary used for the purpose of variously teaching the system of the invention and the various methods as well, and for an explanation of the details of establishing of a perception zone (to function as a circumscribed perception-coverage region), for example, upon the exact footprint of any pre-determined physical space 101, and also for an explanation of how vision-perception sensors and zoning-sensors can be employed to operate for a perception zone.

FIG. 3 is a drawing showing a perspective view of the same perception zone 501 as was shown in FIG. 2. In FIG. 3, the three dimensions applicable to 501, are shown, through labels; 001, 002 and 003. As a brief summary of some aspects, it can be said that FIG. 3 can be referenced for an introductory explanation of; how the volumetric space of a perception-coverage region may be circumscribed, how a discrete position-location within that volumetric space could be referenced, by referencing the position-location coordinates of a sub-volume unit, and also how the volumetric space of a perception zone such as 501 for example, could be divided up into the sub-volume units (as explained in the accompanying detailed description).

FIG. 4 is a drawing showing a perspective view of the same perception zone 501 (as was shown in FIG. 2 and FIG. 3 and therein with reference to FIG. 2 and FIG. 3, various aspects were emphasized and various concepts were developed pertaining to 501). As a brief summary of some aspects, it can be said that FIG. 4 can be referenced for; introducing various types of connected-autonomous vehicles such as; 9032, 9052 and 9041, so that their interaction within the system of the invention and with the various methods of the invention, could be explained and understood in further references, herein also introducing two types of transient, moving obstacles; 1032 and 1041, so that their treatment within the system of the invention and within the various methods of the invention could be explained and understood in further references, and, herein also introducing a transient, static obstacle 1031, so that the treatment of such obstacles, could similarly be explained and understood in further references.

FIG. 5 is a schematic diagram, in which the various constituent elements that a perception mast 1010 could have, are presented as a numerical list of items in the table labelled 1010 in FIG. 5 (and therein the accompanying description, the details regarding the constituent elements are provided). Also, in FIG. 5, the table labelled 90 shows a numerical list of components (having similar functionality in some cases to the constituent elements of a 1010), that may be on-board (i.e. being upon or within) any connected-autonomous vehicle 90.

FIG. 6 is a schematic diagram, providing a list of the various categories of notifications comprising a perception-based notification file, and the perception-based notification file is referenced through label 1010.90 and showing therein, the various categories of notifications, which include; 100, 200, 300, 400, 500 and 600 (and these are described in the accompanying description with reference to FIG. 6). As a brief summary of some aspects, it can be said that FIG. 6 can be referenced for explaining that, a perception-based notification file 1010.90 could be provisioned for transmission from any perception mast 1010 such as the perception mast 1010.501.1, to any connected-autonomous vehicle 90, and 90 includes; 9032, 9041 and 9052. Thus various categories of notifications could be shared, in addition to sharing the perception outputs, and the shared coordinate-frame of the perception outputs underpins the sharing of the other categories of notifications as well. In preferred embodiments, 1010.90 would be provisioned multiple times during one second. In other embodiments, 1010.90 would be communicated by any 90 to any component device or system, within the system of the invention, for onward transmission to any 1010 such as to 1010.501.1 (for example, as shown). Thus perception outputs and perception-based intelligence would flow from one vision-perception sensor to any other vision-perception sensor, again on the basis of a commonly understood shared coordinate-frame.

FIG. 7 is a schematic diagram, providing a list of the various categories of notifications comprising a perception-based notification file, and the perception-based notification file is referenced through label 1010.90 and showing therein, the various categories of notifications, which include; 100, 200, 300, 400, 500 and 600 (which are described with reference to FIG. 6). As a brief summary of some aspects, it can be said that FIG. 7 can be referenced for explaining that, a perception-based notification file 1010.90 could be propagated, for transmission, via; any component, any device, or any system mediation, from any perception mast 1010 to any other perception mast 1010, such as for example, from the perception mast 1010.514.1 to the perception mast 1010.514.2.

FIG. 8 is schematic diagram, providing a list, of data sets comprising the notification category; perception outputs 200, and 200 would be for any given perception zone. Further, 200 for any given perception zone would comprise of data sets labelled; 201, 211, 221, 231, 241 and 251. As a brief summary of some aspects, it can be said that the accompanying description with reference to FIG. 8 explains the details of the core, notification category (being the perception outputs 200) within a perception-based notification file, and how the data sets within 200 are determined.

FIG. 9 is a drawing showing a perspective view of a road segment, and the road segment is within a geographic zone labelled 22, and a perception zone 502 (having two distinct portions within it) is shown as having been established upon a pre-determined physical space 101, upon a portion of the road segment. As a brief summary of some aspects, it can be said that FIG. 9 can be referenced for an explanation of how (with reference to 502) the physical measurements pertaining to a perception zone can be determined and configured along three dimensions and how the (representative) measurements of the smaller-cuboids (sub-volume units of a perception zone) can also be determined and configured, in order to arrive at a three-dimensional data representation scheme (and some variations of it are described alongside), for referring to various discrete position-location within a perception zone.

FIG. 10 is a drawing showing a two-dimensional, grid representation, therein showing a two-dimensional, top-down view of a perception zone 502 (and as corresponding to the determined, three-dimensional measurements pertaining to 502, as described with reference to FIG. 9). As a brief summary of some aspects, it can be said that FIG. 10 can be referenced for an explanation of the situational context, as during a particular, referenced, window of time, of; transient, static obstacles being within 502 and therein, each being referenced in terms of its system-assigned identity, transient, moving obstacles being within 502 and therein, each being referenced in terms of its system-assigned identity, and any transient, moving obstacle that may have come to be in a still state within 502 and therein being referenced in terms of its system-assigned identity.

FIG. 11 is a drawing showing a two-dimensional, grid-representation, being a type of a grid occupancy map, therein showing a two-dimensional, top-down view of a perception zone 502. As a brief summary of some aspects, it can be said that FIG. 11 can be referenced for an explanation of, how, the occupancy position, as during a particular, referenced, window of time, of a transient, static obstacle such as 1031.1 (as shown for example), that is occupying (as shown in FIG. 10), a portion of a total of two grid-squares (as in this example), upon the two-dimensional, grid-representation, therein the occupancy position, of 1031.1 could be conveyed through the position-location coordinates (or the unique identities) of each of the two grid-squares accounting for the occupancy position of 1031.1.

FIG. 12 is a drawing showing a two-dimensional, grid-representation, also being, a type of a grid occupancy map, therein showing a two-dimensional, top-down view of a perception zone 502. As a brief summary of some aspects, it can be said that FIG. 12 can be referenced for an explanation of, how, the occupancy position, as during a particular, referenced, window of time, of a transient, moving obstacle such as 1032.1 (as shown for example), that is occupying (as shown in FIG. 10), some portion of or all of, a total of forty grid-squares (as in this example) upon the two-dimensional, grid-representation, therein the occupancy position, of 1032.1 could be readily conveyed through the position-location coordinates (or the unique identities) of just four of the grid-squares at the four corners of the occupancy position of 1032.1.

FIG. 13 is a drawing which shows a close-up perspective view of the exact same perception zone 502 within 22, as was shown earlier in FIG. 9. As a brief summary of some aspects, it can be said that FIG. 13 can be referenced for an explanation of, how the position-location coordinates of a transient, moving obstacle (that has come to be in a still state) could be expressed as three-dimensional position-location coordinates within the context of a perception zone.

FIG. 14 is a drawing which shows how the position-location coordinates, of the occupancy position of a transient, moving obstacle 1041.1 within 502, are shown as being expressed in terms of, both, three-dimensional position-location coordinates (herein being any excerpt from a three-dimensional, grid occupancy map) as well as two-dimensional position-location coordinates, being excerpted from a two-dimensional, grid occupancy map (herein 1041.1 is a transient, moving obstacle that may have come to be in a still state during a particular, referenced window of time).

FIG. 15 is a drawing which shows a perspective view of a road segment, and the road segment is shown to be in a geographic zone labelled 24 and therein, three perception zones; 505, 506 and 507 are shown to have been established. As a brief summary of some aspects, it can be said that FIG. 15 can be referenced for an explanation of how a three-dimensional, grid occupancy map would be constructed, to therein represent various detections, and also how, even though; 505, 506 and 507, have been established contiguously, but, the data representation scheme within each perception zone could be determined so as to operate independently within each perception zone with respect to representing the data pertaining to each perception zone distinctly.

FIG. 16 is a drawing, in which, within three distinctly labelled boxed sections; 25, 26 and 27, various, contiguously established perception zones, being of same or different dimensional scale relative to each other, are shown, as being contiguous to each other along various dimensions.

FIG. 17 is a drawing which shows a perspective view of a road segment, and the road segment is shown to be in a geographic zone labelled 28 and therein, a set of perception zones, comprising, three, contiguously established perception zones; 514.1, 514.2 and 514.3, is shown to have been established. As a brief summary of some aspects, it can be said that FIG. 17 can be referenced for an explanation of how another type of three-dimensional, grid occupancy map would be created to represent various detections, and also how, a set of perception zones, could be configured to function such that the data representation scheme, operates as, a conjoint data representation scheme, within the whole of the collective region of the set of perception zones (with no independent data representation scheme operating for each perception zones within the set).

FIG. 18 is a drawing showing a perspective view of the same set of perception zones comprising, three, contiguously established perception zones; 514.3, 514.2 and 514.1 (shown earlier in FIG. 17). As a brief summary of some aspects, it can be said that FIG. 18 can be referenced for an explanation of how, with knowledge of the position-location coordinates describing the occupancy positions of; a transient, static obstacle 1031.7 and a transient, moving obstacle 1032.4, any of the various potential entry points labelled; 9.1, 9.2, 9.3, 9.4 and 9.5, could be declared as being viable and/or un-viable entry points, for the purpose of a connected-autonomous vehicles, such as 9032.1, for entering into or for the purpose of traversing through any section or any portion of the any free-space within the set of perception zones.

FIG. 19 is a drawing showing a two-dimensional, grid-representation being a type of a grid occupancy map, therein showing a two-dimensional, top-down view of a perception zone 502. As a brief summary of some aspects, it can be said that FIG. 19 can be referenced for an explanation of, how perception-based advance guidance can be created for connected-autonomous vehicles or for manually driven connected-vehicles based on the relevant, position-location coordinates, pertaining to the occupancy position of transient, static obstacles being upon any part of the drivable space 1030 within 502. It is explained therein how a (virtual) blockade of a portion of 502 could be determined on the basis of the relevant position-location coordinates, represented as a grid occupancy map, for notifying vehicles in advance of approaching the perception zone.

FIG. 20 is drawing which shows a representative view of a perception zone 515, established at a junction of two roads, within a geographic zone labelled 30, and as a brief summary of some aspects, it can be said that FIG. 20 can be referenced for an explanation of the interaction between two different types of connected-autonomous vehicles, a perception mast labelled 1010.515.1 and a central server labelled 1011, in relation to regulating the flow of traffic through the perception zone by (virtually) blockading an entry face of the perception zone 515 for one vehicle, till the other has passed through 515 at the junction.

FIG. 21 is a schematic diagram, and as a brief summary of some aspects, it can be said that FIG. 21 can be referenced for an explanation of, how a central server labelled 1011 could, in addition to transmitting perception-based notification files 1010.90 to connected-autonomous vehicles, could additionally, aggregate, among other data, the perception outputs encoded within any 1010.90 pertaining to one or more perception zones, and create additionally, further types of perception-based notification files 1011.90 based on further data sets that are labelled; 700, 800 and 900, and therein transmit any type of perception-based notification files to various types of connected-autonomous vehicles.

### DETAILED DESCRIPTION

The following detailed description refers to the accompanying drawings. Embodiments of the present disclosure are described herein, however, it is to be construed that the disclosed embodiments are merely illustrative and explanatory and other embodiments can take various and alternative forms. The accompanying drawings are not to scale; some features could be exaggerated or minimized to show details of particular components. Therefore, specific structural and functional details disclosed herein are not to be interpreted as limiting, but merely as a representative basis for teaching one skilled in the art to variously employ the invention. As those of ordinary skill in the art will understand, various features illustrated and described with reference to any one of the drawings can be combined with features illustrated in one or more other drawings to produce embodiments that are not explicitly illustrated or described.

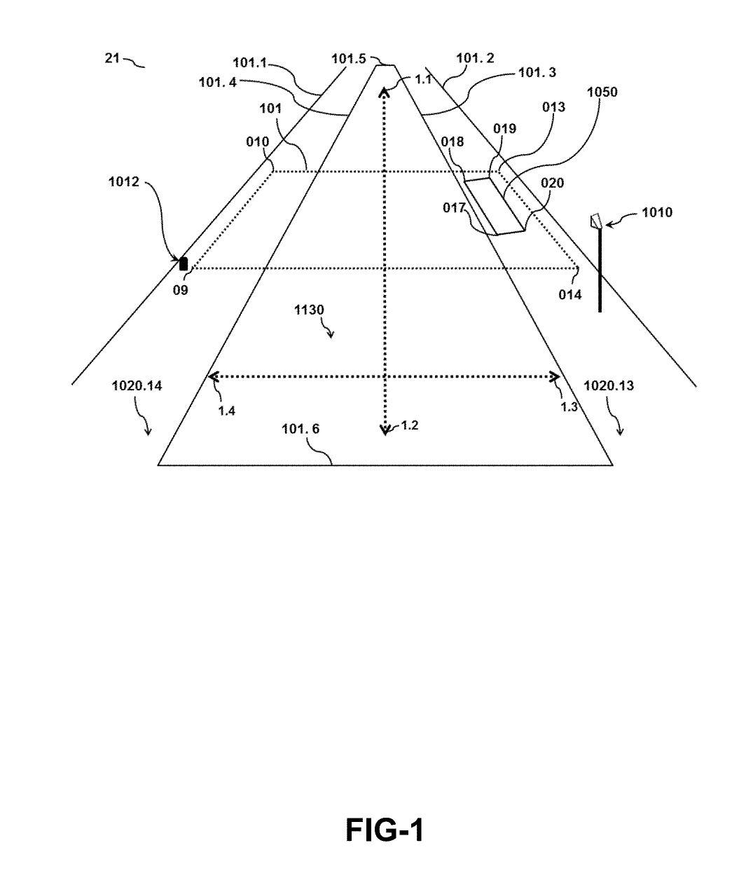

Reference is made to FIG. 1. A road segment is shown, in a perspective view, as a trapezoid bounded within four edge lines labelled; 101.3, 101.4, 101.5 and 101.6 (and as shown, the edge line 101.5 is the farthest end of the road segment in the perspective view), and 1130 is a label for depicting the drivable surface upon the shown road segment. As the case may be, the road segment may be for the use of various types of vehicular traffic. A geographic zone, is referenced with the label 21, and the road segment is shown to be a road segment within the geographic zone 21, and 21 may be a unique identifier for this specific geographic zone. In some embodiments any other type of unique identifier may be used for distinguishing one geographic zone from any other geographic zones, as the case may be. The geographic-orientation of the road segment can be depicted with the help of two orientation-axes. For example, as shown, a first orientation-axis is the axis marked at its one end with label 1.1 at its other end with the label 1.2. A second orientation-axis is the axis marked at its one end with label 1.3 and at its other end with the label 1.4. In some embodiments, a ‘true orientation’ of the first orientation-axis could be determined in relation to, or with reference to, ‘true North’ of global compass coordinates, and the ‘true orientation’ of the second orientation-axis could be determined similarly, in relation to, or with reference to, ‘true North’ of global compass coordinates. In other embodiments, a ‘local orientation’ of the first orientation-axis may be determined with reference to the road segment and this ‘local orientation’ may be the physical orientation of the road segment along the orientation of its edge line labelled 101.4 or along the orientation of its edge line 101.3. Similarly, a ‘local orientation’ of the second orientation-axis may be determined with reference to the road segment and this ‘local orientation’ may be the physical orientation of the road segment along the orientation of its edge line labelled 101.5 or along the orientation of its edge line 101.6.

In FIG. 1 the label 1020.13 refers to a portion of a footpath or a portion of a pedestrian walkway, and as the case may be, 1020.13 may be for the use of; pedestrians, cyclists, wheelchair users, low-speed delivery pods, low speed drones, droids, aerial drones, or similar, (but not be permitted for the use of any type of vehicular traffic. In FIG. 1 the label 1020.14 refers to a similar portion of a footpath or a portion of a pedestrian walkway, being on the other side of the road segment. 101.2 as shown, references an outer verge boundary of 1020.13 whereas 101.3 serves as a reference for an inner verge boundary of 1020.13. Similarly, 101.1 as shown, references an outer boundary of 1020.14 and 101.4 serves as a reference for an inner verge boundary of 1020.14.

As shown in FIG. 1, 101 refers, to a region that is shown as having been determined within 21, to function as a pre-determined physical space, for the purpose of variously implementing the invention in relation to the pre-determined physical space. Accordingly, 101 is the pre-determined physical space, and is being shown in FIG. 1 as a trapezoid (drawn with dotted lines) which has four corner points labelled; 09, 010, 013 and 014. In some embodiments, the pre-determined physical space could be a region being determined such that; it covers only a road segment, or it covers only a portion of a footpath, or it covers only a portion of a pedestrian walkway on one side of a road segment, or it covers various portions of a road segment or a footpath, or it covers any other type of pathway, or it covers any other type of passable space, drivable space or traversable space, being anywhere, so long as any of these have been determined, to function, as the pre-determined physical space. In FIG. 1, 101 as shown, covers; a portion of the road segment, a portion of 1020.13, as well as a portion of 1020.14.

As shown in FIG. 1, reference label 1050 is shown to be situated upon, a portion of 1020.13 that is within 101, and 1050 is shown as being bounded within four corner points labelled; 017, 018, 019 and 020 and, 1050 as shown, represents an area that may be designated for the use, by example of; aerial drones, aerial passenger vehicles/pods, mixed-aerial-ground vehicle, etcetera, and 1050 may be designated for use by these for purposes including for example; landing upon, waiting upon, becoming airborne from, hovering above etcetera. In some embodiments, as the case may be, 1050 may have various dimensions of scale and 1050 could be of any other shape. In other embodiments, 1050 may be upon any elevated section of any type of infrastructure as the case may be, as within 101.

As shown in FIG. 1, 1010 is shown to be a perception mast, and 1010 would be comprising a vision-perception sensor as the main component, and, other components which would be for enabling; wired and/or wireless communications, memory storage and retrieval, machine-vision/computer-vision processing, determination of its own global positioning coordinates. The vision-perception sensor may be for example, any type of; LIDAR, RADAR, stereo camera, monocular camera, or any other type of camera with night and/or day vision capability or with capability for different focal lengths or with capability for measuring time-of-flight or with capability for acquiring any type of a heat map). 1010 is shown, for example, as being physically located upon 1020.13. In some embodiments, multiple vision-perception sensors may be concurrently employed within any 1010 as a redundancy or to leverage the different capabilities of different types of vision-perception sensors or for fusing the multiple data feeds from various similar or different sensors. In other embodiments, a vision-perception sensor being situated or being located upon or within a moving vehicle or upon or within an aerial drone, as the case may be, (and while having a field-of-view or while having a range-of-perception-sensing of a scene therein, as within, the determined region, such as the scene within 101), could be utilised, similarly in some ways to how a vision-perception sensor upon or within any 1010 could be utilised), while variously employing the invention. As shown in FIG. 1, the vision-perception sensor in 1010 is shown as having a field-of-view or a range-of-perception-sensing, of the scene therein, as within, the determined region 101. In various embodiments, for the purposes of variously employing the invention, any 1010 could be variously situated at; different positions, different heights, different perspective angles-of-view, at different locations in relation to any determined region so long as the vision-perception sensor may be having a field-of-view or a range-of-perception-sensing of a scene therein, as within, the determined region, such as the scene within 101.

Also shown in FIG. 1, 1012 is shown to be a zoning sensor, and 1012 as shown, is physically located upon 1020.14, at a location adjacent to the (representative) corner point 09 of the determined region 101 and may be serving as a location referencing device for fixing the precise geo-location of the (representative) corner point 09 of 101, having determined the precise geo-location of 1012 itself as being physically located upon 1020.14 (by using for example ‘Real-time kinematic’ corrections for any satellite-based global positioning system), for determining this precise geo-location of 1012. In various embodiments, 1012 may be a different type of zoning sensor and it could be for example; any type of a microelectromechanical systems (MEMS) sensor and any such, or any different type of zoning sensor could be used for the additional purpose of sensing the motion of any vehicle or any object passing upon it, passing above it or passing beside it, as the case may require for being able to sense the motion of any proximal vehicles being proximal or entering the determined region. In various embodiments, 1012 may be a zoning sensor that may have wired or wireless communication capability to be able to communicate any outcomes that are able to be sensed by it. In some embodiments, any 1012 could be physically located to correspond to the location of any 1010. Thus accordingly, in various embodiments, various different types of zoning sensors such as 1012 may be utilised to additionally acquire various different sensing capabilities, to enhance the functionality and outcomes while variously employing the invention, and their referred sensing capabilities being different from the vision-based ‘perception’ capability of the any vision-perception sensors.

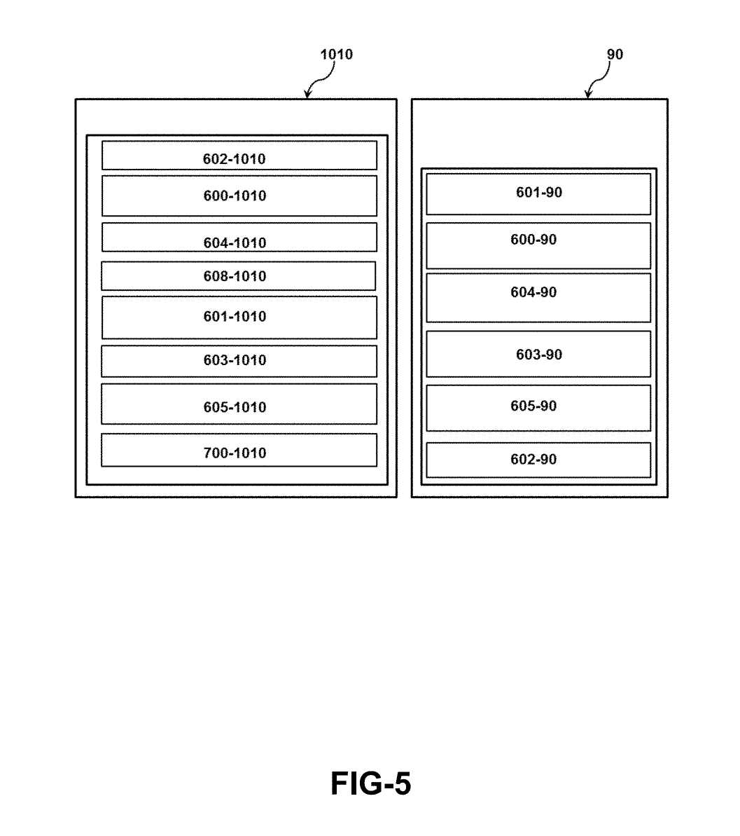

Reference is now made to FIG. 5 in which the various constituent elements that any 1010 could have are presented as a numerical list in the table labelled 1010 in FIG. 5. A first item is listed as 602-1010 which refers to any type of a global position system device which may be utilised to precisely determine the geo-location of 1010. The second item listed is 600-1010 which refers to any type of a vision-perception sensor and 600-1010 is the core constituent element of any 1010. The next item listed is 604-1010 which refers to any type of programmable or pre-programmed machine-vision processor or to any type of any other processor which has any programmed functionality to perform any machine-vision processing tasks and/or any other processing tasks. A further component listed is 608-1010 which refers to a computer memory device of any type. The list further includes an item listed as 601-1010 which refers to any type of a dedicated short-range communication (DSRC) device that can serves as a roadside unit DSRC beacon. In some embodiments 1010 could also have an item listed as 603-1010 which refers to any other transceiver other than a DSRC beacon roadside unit. Also in some embodiments, a next item, listed as 605-1010 refers to any type of a communications processor. Lastly on the list, the item listed as 700-1010 refers to any type of a microelectromechanical system (MEMS) sensor or to any type of zoning sensors such as any 1012 being incorporated as a component part of 1010.

Similar to the functionality that would become possible in the system of the invention, for example through utilising the perception outputs of a vision-perception sensor 600-1010 being at any fixed location (as being within or upon any perception mast 1010 and 1010 itself being at any fixed location), similarly, the system of the invention could utilise the perception outputs of any other vision-perception sensor that may be situated upon any moving vehicle. For example, and referring again to FIG. 5, the table labelled 90 shows a numerical list of components that are on-board (i.e. being upon or within) any connected-autonomous vehicle, and the connected-autonomous vehicle being in either a static state or a state of motion, and the any connected-autonomous vehicle itself being; any type of aerial drone, any type of ground vehicle, or any type of ground drone). The first item listed in table labelled 90 in FIG. 5 is 601-90 which refers to a DSRC antenna (being a DSRC on-board unit). The second item, 600-90 refers to any vision-perception sensors on-board the any connected-autonomous vehicle and 600-90 would also serve as an important component within the system of the invention and 600-90 would contribute perception outputs to the system, similar to the central functionality achieved through utilising the perception outputs of any 600-1010 being within or upon any 1010. Next on the list in table labelled 90 is 604-90 which refers to any type of machine-vision processor or any other type of processor being used to process the perception feed being available through 600-90. Further on the list is 603-90 which refers to any other type of radio transceiver other than any 601-90, as the case may be. Also, 605-90 refers to any type of communications interface or communications processor on-board the any connected-vehicle for supporting or enabling any of; infrastructure-to-vehicle communications, vehicle-to-infrastructure communications, vehicle-to-vehicle communications. The last item listed in table 90 is 602-90 which refers to any type of global position system (GPS) unit on-board the any connected-vehicle and which serves the purpose of dynamically determining, as precisely as the case may be, the geolocation coordinates of the any connected-vehicle. Thus FIG. 5 provides an overview of the various component elements within any perception mast such as 1010 as well as relevant components that may be operating within any connected-vehicle (and the connected-vehicle may itself be a connected-autonomous vehicle, having any level of autonomous operation capability).

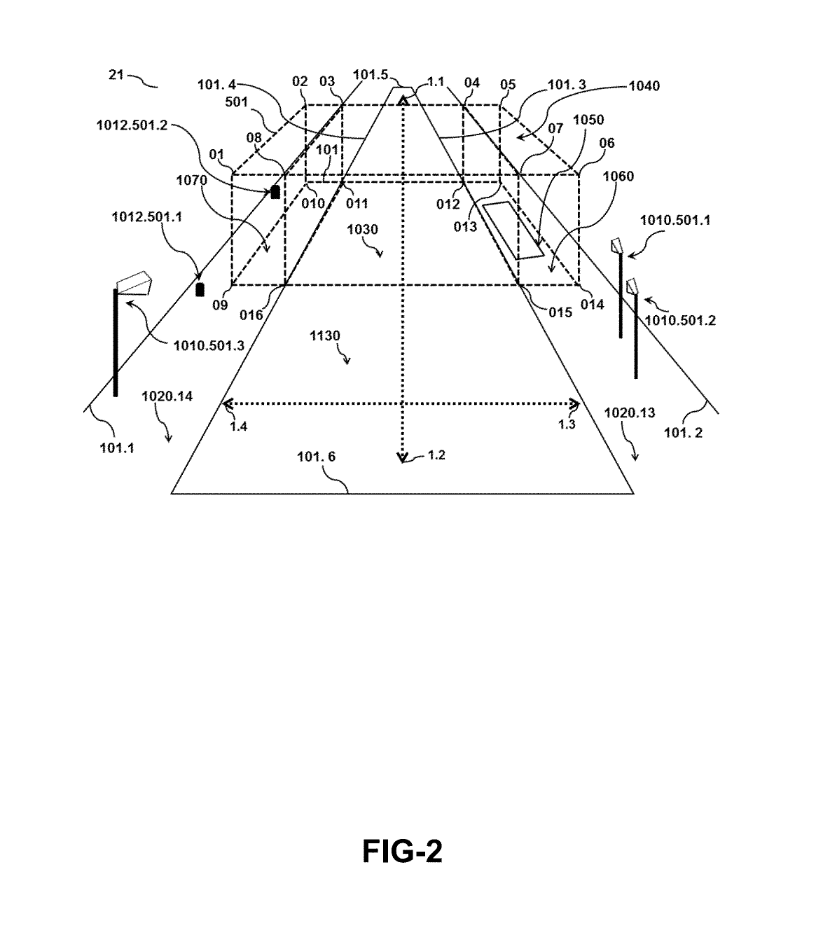

Reference is now made to FIG. 2 which shows the same geographic zone 21 with the same road segment, shown in the shape of a trapezoid bounded within edge lines labelled; 101.3, 101.4, 101.5 and 101.6 and 1130 is a label for depicting the drivable surface upon the road segment, similar to as was shown in FIG. 1. In some embodiments, conforming to the exact footprint of 101, a perception zone, labelled 501, as shown in FIG. 2 may be established, and 501 as shown is represented in the shape of a cuboid. The full dimensional scale of 501 can be referenced through referencing four (representative) corner points labelled; 01, 02, 05, 06 at the top face of 501, and another four (representative) corner points labelled as; 09, 010, 013, 014 at the base of 501. These eight corner points are the extreme boundary corner points of 501 and all of the space bounded within these eight corner points (and therefore within the whole of 501) is referenced with a label 1040. In some embodiments, the perception outputs needed for creating various navigation guidance and coordination enablements, for, connected-vehicles (that may be operating at any level of autonomous operation, or, being operated manually), could be mapped to any, two-dimensional or three-dimensional, location coordinate scheme being made applicable to a perception zone such as 501. In other embodiments, the perception outputs needed for creating various navigation guidance and coordination enablements, for, connected-vehicles (that may be operating at any level of autonomous operation, or, being operated manually), could be mapped to any two-dimensional location coordinate scheme being made applicable to the pre-determined physical space such as 101, even without having established a perception zone (such as 501) upon or within any part of 101, and therein the expression of any aspect of the vertical height of any perception outputs could still be encoded as a height parameter being directly above any two-dimensional point at the base of 101.

In some embodiments, the dimensions of 501 (or the dimensions of 101) may be represented as physical measurements being annotated in an image-frame of any vision-perception sensor, for example being annotated in the image frame of any 600-1010 being within or upon, for example, the perception mast 1010.501.1 being shown in FIG. 2. In some embodiments, the precise location and the physical measurements of a perception zone (or the pre-determined physical space 101) may be represented as annotations within any type of three-dimensional or two-dimensional maps that are ordinarily used for autonomous driving, for the purpose of localisation. In some embodiments, the geolocation coordinates of the various (representative) corners or edges of any perception zone such as 501 (or any pre-determined physical space such as 101) can be also determined through any global position system coordinates and, additionally or alternatively, any (representative) corner points of any perception zone can be physically demarcated by using any type of zoning sensor such as 1012 shown in FIG. 1 in which case the zoning sensor's geolocation coordinates would correspond to any specified (representative) corner or edge location of a perception zone. Any perception outputs of a perception feed being acquired by, a vision-perception sensor, for example by; a 600-1010 in 1010.501.1, and/or by a 600-1010 in 1010.501.2, and/or by a 600-1010 in 1010.501.3, would initially be in terms of the coordinate-frame-of-reference of the vision-perception sensor itself. Thereafter, the location coordinates of the any perception outputs could be mapped to, and thereby be expressed in terms, of a data representation scheme applicable to 501 or applicable to 101, and therein the data representation scheme, the locations coordinates of the any perception outputs being expressed as position-location coordinates pertaining to various discrete positions within 501 or 101. These position-location coordinates could thereafter be transformed into any other coordinate-frame-of-reference, for example into the coordinate-frame-of-reference of any other perception mast or into a coordinate-frame-of-reference relevant to any connected-autonomous vehicle, and this could be achieved through performing a coordinate-transform, and a coordinate-transform could be performed by a processor on-board the any connected-vehicle, for example by any 604-90, or the coordinate-transform could be performed by any 604-1010.

In some embodiments a perception zone could have more than one portion within it. For example, as shown in FIG. 2, the perception zone 501 is shown as having three portions. A first portion of 501 can be referenced as being bounded by the eight (representative) corner points labelled; 04, 05, 06, 07, 012, 013, 014 and 015, and accordingly as shown, this first portion covers a part of 1020.13 and this first portion accordingly covers a segment of a footpath or of a pedestrian walkway. The ground surface at the base of the first portion within 501 is labelled as 1060.

As shown in FIG. 2, a second portion of 501 can be referenced as being bounded by eight (representative) corner points labelled; 01, 02, 03, 08, 09, 010, 011 and 016, and accordingly as shown, this second portion covers a part of 1020.14 and this second portion accordingly covers a segment of a footpath or of a pedestrian walkway on the other side of the road segment. The ground surface at the base of this second portion within 501 is labelled as 1070.

As shown in FIG. 2, a third portion of 501 can also be referenced as being bounded by eight (representative) corner points labelled; 03, 04, 07, 08, 011, 012, 015 and 016, and accordingly as shown, this third portion covers a part of the road segment itself, and 1030 is a label for depicting the drivable surface, upon the shown road segment, within 501. Thus as shown, while 1030 and 1130 both refer to the drivable surface upon the same road segment, 1030 is specifically that part of the road segment which is within 501, whereas 1130 is the remaining part of the same road and 1130 is not within 501.

Again referencing FIG. 2, three perception masts, similar to the perception mast 1010 shown in FIG. 1, are shown in FIG. 2 (and these have been assigned a reference number given after 1010 to denote the perception zone within which these are operative as well as a serial number identifier to separately identify the perception mast and the serial number identifier follows the perception zone reference), and the first perception mast established to operate for the perception zone 501 is accordingly shown labelled as 1010.501.1. The second perception mast established to operate for 501 is labelled as 1010.501.2 and the third perception mast established to operate for 501 is labelled as 1010.501.3. In various embodiments, different perception masts could have within them (or upon them) similar or different types of vision-perception sensors 600-1010, or all could have the same type of 600-1010 in them. In some embodiments, different perception masts could be utilised to independently operate for various portions of 501 whereas in other embodiments a plurality of perception masts could be utilised to operate together for a single portion of 501. In yet other embodiments, the perception feed acquired from any 600-1010 in any perception mast could be ‘fused’ or could be ‘stitched’, as would be apparent to one skilled in the art regarding ‘fusing’ and ‘stitching’, with the perception feed acquired from another 600-1010 being on another perception mast. As would be apparent to one of ordinary skill in the art, that more than one 600-1010 of the same or different types could also be used as part of a single perception mast (and the perception feeds of these could be fused or stitched in any way as well). Thus as would be apparent to one skilled in the art, the perception outputs (being given as location coordinates of various types of detections) from any variously located, static or moving vision-perception sensors could be utilised, including as well, similar perception outputs, from any vision-perception sensors such as any 600-90 being on-board any connected-autonomous vehicle, could be similarly utilised with respect to a given perception zone or a given, pre-determined physical space, so long as the 600-90 may be having a line-of-sight or a field-of-view of, the scene within the perception zone or within the pre-determined physical space, and if, the precise geolocation coordinates of the 600-90 at the time, are known, and also if, the sensor parameters of 600-90 are known through a prior calibration having been performed for 600-90 in reference to the demarcated space of the perception zone or in reference to the demarcated space of the pre-determined physical space.

1050 shown in FIG. 2 refers to the same as, 1050, which was shown bounded with four (representative) corner points labelled; 017, 018, 019 and 020 in FIG. 1. Two, numbered zoning sensors, similar to zoning sensor 1012 shown in FIG. 1 are shown in FIG. 2 and the first of these is shown with label 1012.501.1 and it is a first zoning sensor operative in 501 and in some embodiments it may be used to demarcate the location of (the representative) corner point 09 of 501 by cross-referencing to its own precisely measured geolocation. The second zoning sensor in 501 is shown with label 1012.501.2 and it may be used similarly, to demarcate the location of (the representative) corner point 010 of 501 by cross-referencing to its own precisely measured geolocation. In some embodiments, a zoning sensor 700-1010 (and 700-1010 being similar to or same as, any 1012) could be incorporated as a component within any perception mast and could be used to demarcate the height or any other representative position of any perception zone, by cross-referencing to its own precisely measured geolocation as well as thereby reference the precise geolocation of the perception mast as well. As would be apparent to those skilled in the art, any zoning sensor such as 1012 or such as 700-1010 may have any mechanism to ‘sense’, and this ‘sensing’ being any type of ‘microelectromechanical sensing’ and this ‘sensing’ being distinct from the vision-perception sensing done by any vision-perception sensor). Accordingly, as described, any 1012 or any 700-1010 may be using any low power micro-electro-mechanical system for enabling a sensory reading, and may also have a communication module and may be able to serve as a wireless (or wired) sensor network node. In some embodiments, any zoning sensor such as 1012 or such as 700-1010 may be of the form of an optical sensor or it may be a pressure sensor. As those skilled in the art will understand, 1012 or 700-1010 may be employed to ‘sense’ through various other mechanisms and may emit pulses or signals to detect motion and to transmit location and instance of sensed motion and may transmit their own location to other sensors or to connected-vehicles through, various employable communication mechanisms for sensor-to-sensor, or sensor-to-vehicle communications. In some embodiments zoning sensors such as 1012 or 700-1010 may be employed purely for electronic location-tagging of various; (representative) path corners, path edges, heights in relation to paths, etcetera. FIG. 2 thus explains some details of establishing a perception zone upon the exact footprint of any pre-determined physical space, and also explains how vision-perception sensors and zoning-sensors can be employed to operate for a perception zone, as well as how a perception zone could be established (to function as a circumscribed perception-coverage region) with multiple portions. In some embodiments, a perception zone could be established upon just the road segment or upon just the segment of a footpath or pedestrian walkway, as the case may require or as may need to be determined due to any requirements of traffic coverage. In yet other embodiments, two or more distinctly operative perception zones could be established upon various portions of the footprint of any pre-determined physical space.

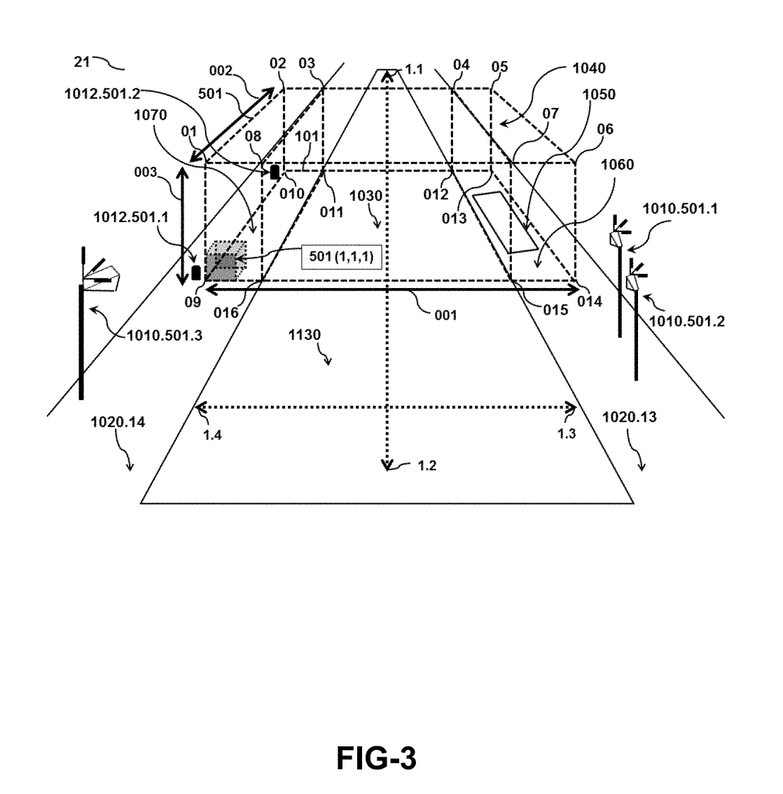

Reference is now made to FIG. 3 which shows the same perception zone 501 upon the exact footprint of the determined region 101, in geographic zone 21, as was shown in FIG. 2. In FIG. 3, three dimensions are shown, through labels; 001, 002 and 003. The dimension 001 refers to the horizontal width dimension, of 101 and of 501. The dimension 002 refers to the horizontal depth dimension, of 101 and 501. The dimension 003 refers to the vertical height dimension, directly, of 501 and could be indirectly attributed, to the region vertically above the base of 101 along 003. The measurement values of 101 and 501 along; 001, 002 and 003 would in some embodiments, collectively circumscribe the volumetric space of the applicable perception-coverage region applicable to 501 and 101. As would be apparent to one skilled in the art, in some embodiments, a perception zone such as 501 may not be established, however, the volumetric space of a perception-coverage region applicable to 101 could be circumscribed simply by using any determined measurement values along three dimensions 001, 002 and 003.

Once a volumetric space of a perception-coverage region has been circumscribed, the location of any obstacle detected within that volumetric space can be represented within the context of that volumetric space by referencing the position-location coordinates of the volumetric space itself. Any motion or change of state of the any detected obstacles could also similarly be tracked within the circumscribed context of the volumetric space. It is possible the a certain detected obstacle continues to be detected in the coordinate-frame of reference of the LIDAR even after it has moved to a location outside the circumscribed volumetric space. However, in that scenario, its location coordinates would no longer be shown within the system of the invention because it is no longer within the perception-coverage region being either; the pre-determined physical space 101, or the perception zone 501. Similarly, using multiple vision-perception sensors (each with different fields of view of the perception-coverage region), their perception outputs could be fused to obtain very robust perception in relation to the perception-coverage region such that no occlusion-of-view may be applying to the whole of the perception-coverage region when viewed from any perspective angle. Thus accordingly, a significant improvement may be achieved by using the system of the invention, over the perception that may otherwise be available to a connected-autonomous vehicle from using only its own on-board vision-perception sensors, to the extent of the perception-coverage region.

Reference is again made to FIG. 3 which shows a smaller-cuboid (being the smallest measurement unit within the perception zone) with a coordinate-label that reads 501(1,1,1). Herein the coordinate-label, the term outside the brackets is an identifier referring to the perception zone, and the term within brackets represents coordinate location values expressed in the nomenclature; (‘x’,‘y’,‘z’) wherein ‘x’ is the coordinate location value along the dimension 001, ‘y’ is the coordinate location value (of the same position-location) along the dimension 002, and ‘z’ is the coordinate location value (also of the same position-location) along the dimension 003. Accordingly, the coordinate-label 501(1,1,1) that labels the smaller-cuboid as shown, is indicative of the position-location coordinates that can be used to reference that part of the volumetric space of 501, which corresponds to the volumetric space being occupied by the smaller-cuboid, as shown (whatever the volumetric space of the smaller-cuboid may be, in different cases, as determined).

In some embodiments, any part of or the whole of a perception zone such as 501, could be divided into any number of smaller-cuboids, and the smaller-cuboids essentially being sub-volume units of 501, and this could be achieved through several approaches, as would be apparent to one skilled in the art, including ‘voxelisation’, through any various volumetric representation models. In some other embodiments, any part of or the whole of the perception zone 501 could be divided into any number of smaller-cuboids through plane-slicing the circumscribed volumetric space of 501 at various intervals along the three dimensions; 001, 002 and 003. Therein, the smaller-cuboid shown with coordinate-label 501(1,1,1) would be the first smaller-cuboid within 501 and its position-location would be the first discrete position along each of the three dimensions, and; its position-location along 001 being given by the ‘x’ value, its position-location along 002 being given by the ‘y’ value, and its position-location along 003 being given by the ‘z’ value, and herein, with a point of origin for the coordinate scheme may be located at the (representative) corner point labelled 09.

In various embodiments, the number and size (size herein being volumetric scale) of the smaller-cuboids to be used to represent the location coordinates within any perception zone may be determined on the basis of the actual measurements of the perception zone along; 001, 002 and 003 and the choice as determined, would also determine, the level of resolution of data representation, of the detections of various obstacles, that would be possible within perception zone, within which the chosen position-location referencing scheme is being employed. A higher level of resolution of data representation would obviously be possible by using a greater number of smaller-sized, sub-volume units, within the circumscribed volumetric space, of the perception-coverage region, of a given perception zone. In various embodiments of the system of the invention, different levels of resolution of data representation may be employed for various different perception zones. In other embodiments, different levels of resolution of data representation may be employed at different times within a same perception zone. Further, in yet other embodiments, different levels of resolution of data representation may be employed for various distinct portions within a single perception zone. As one skilled in the art would recognize, that in various other embodiments, within any distinct portion of a perception zone, or within the whole of a perception zone, it may be possible to vary the level of resolution of data representation, also by, varying the scale of each of the smaller-cuboids, along any, one or more, of the three dimensions; 001, 002 and 003.

For one skilled in the art, it may be recognised that the chosen level of resolution of data representation may be determined on the basis of various things. For example, the level of resolution of data representation may be determined in response to the actual achieved image resolution level (e.g. number of pixels or number of data points in LIDAR pointcloud data) of the perception feed being acquired by any vision-perception sensor. Or, it may be determined in response to the data resolution level of any perception outputs (e.g. the density or sparsity of data points pertaining to any confirmed detection). Additionally, the type, size and operating speeds of any connected-autonomous vehicles, expected to be passing through the perception-coverage region, as well as the expected congestion levels, and types of transient, obstacles expected to be encountered within the context of the circumscribed volumetric space, would affect the requirement of a particular level of resolution of data representation with a particular perception zone. In some embodiments, only a two-dimensional representation of only the ground surface portions, such as 1030, 1070 and 1060, of a perception zone, may be needed to be represented, and thus a determination of the levels of resolution of data representation would pertain to a two-dimensional, grid representation, based on similar principles, and would be for example, a higher level of resolution of data representation if a larger number of smaller squares were used for a two-dimensional, grid upon the base of 501.

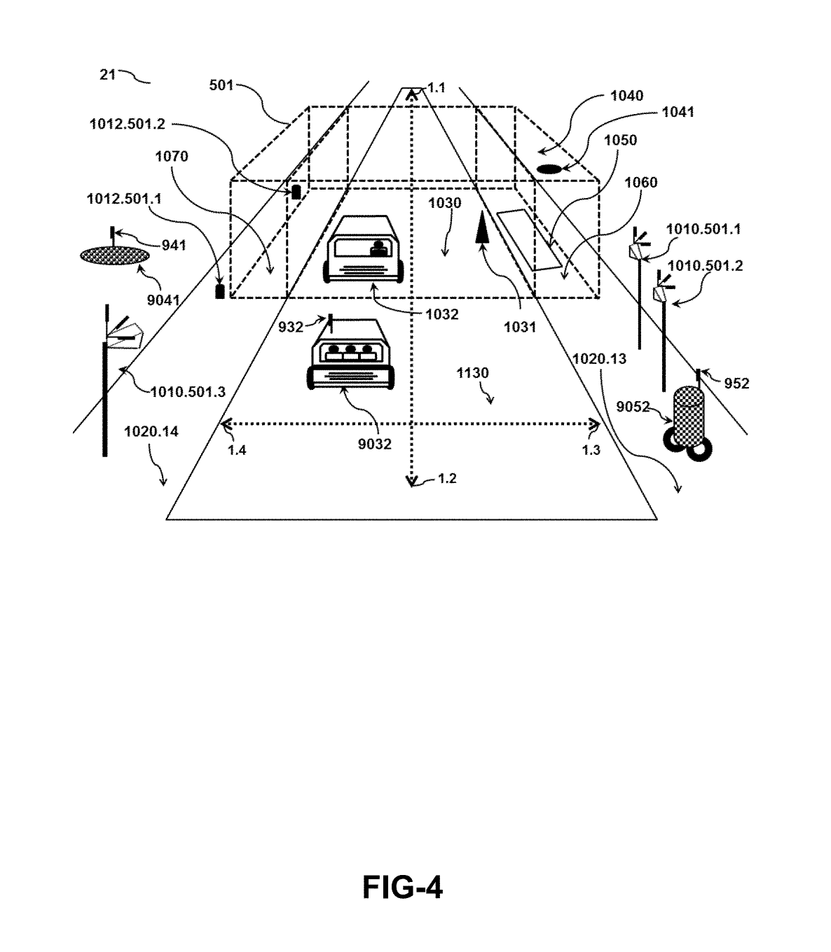

Reference is now made to FIG. 4 in which the same perception zone 501, in geographic zone 21, as shown in FIG. 3 is shown again in FIG. 4 however labels; 01, 02, 03, 04, 05, 06, 07, 08, 09, 010, 011, 012, 013, 014, 015 and 016, that were shown at various (representative) corner points and other points with 501 in FIG. 3 are not explicitly shown in FIG. 4 for avoiding excess labelling clutter, but these labels are to be inferred as applicable reference labels for FIG. 4 exactly as per FIG. 3. Similarly, the labels for dimensional reference; 001, 002 and 003 are not explicitly shown in FIG. 4 but these labels are to be inferred as applicable reference labels for FIG. 4 exactly as per FIG. 3. Furthermore, the coordinate system being used to represent various locations within the circumscribed space is also not explicitly labelled or referenced through any smaller-cuboid nor are the accompanying position-location coordinate values (‘x’,‘y’,‘z’) of any smaller-cuboid, explicitly labelled or referenced in FIG. 4 however these are also to be inferred as applicable references within FIG. 4 exactly as per FIG. 3. Similarly, the corner point references for 1050 which were shown as; 017, 018, 019 and 020 in FIG. 1 are not explicitly shown in FIG. 4 but are to be inferred as applicable references within FIG. 4 as per FIG. 1.

FIG. 4 introduces a static obstacle and a number of different types of vehicles into the scene, and elaborates the referencing scheme for these, and these different types of vehicles include, ground and aerial vehicles and some of these are connected-autonomous vehicles (operating at any level of autonomous operation). In FIG. 4, an ordinary road vehicle 1032 is shown to be moving through 501 and 1032 and is shown as not being a connected-vehicle and not being a connected-autonomous vehicle and 1032 would accordingly be a manually driven vehicle. As shown, 1032 is within 501 and upon 1030 and further, 1032 can be referred to as a transient, moving obstacle within 501 from the perspective of other vehicles intending to enter or pass through any part of the space upon or above 1030.

FIG. 4 also shows 1031 and 1031 refers to a transient, static object within 501 which may for example be a traffic cone or any other type of static obstacle being placed upon 1030. Also, 1041 refers to any aerial drone or other aerial pod or vehicle and it is shown as being a moving aerial vehicle but it is not a connected-vehicle. In FIG. 4, as shown, 1041 is within the aerial space above 1060 and, for example as the case may be, 1041 may be coming in to land upon 1050, accordingly 1041 may be also be referred to as a transient, moving obstacle. Also, 9032 is shown in FIG. 4 and 9032 is a connected-autonomous vehicle, and is shown as moving upon 1130 and it may be that 9032 may be operating at any level of autonomous operation, but it is outside 501 as shown, and 932 is shown as being any type of a wireless transceiver, on-board 9032. Further, 9041, which is shown as connected-autonomous vehicle and 9041 is an aerial drone outside 501 and 9041 as shown may be operating at any level of autonomous operation. 941 is shown as being any type of a wireless transceiver, on-board 9041. Also, 9052 refers to connected-autonomous vehicle and 9052 is shown as a ground vehicle, and it is outside 501 and upon 1020.13 and 9052 would also refer to any robotic platform or droid for deliveries or for any other purpose and 952 is shown as being any type of a wireless transceiver, on-board 9052. In other variations as the case may be, 932, 941 and 952 may be the antennae of DSRC vehicle ‘on-board units’ for vehicle to infrastructure communications.

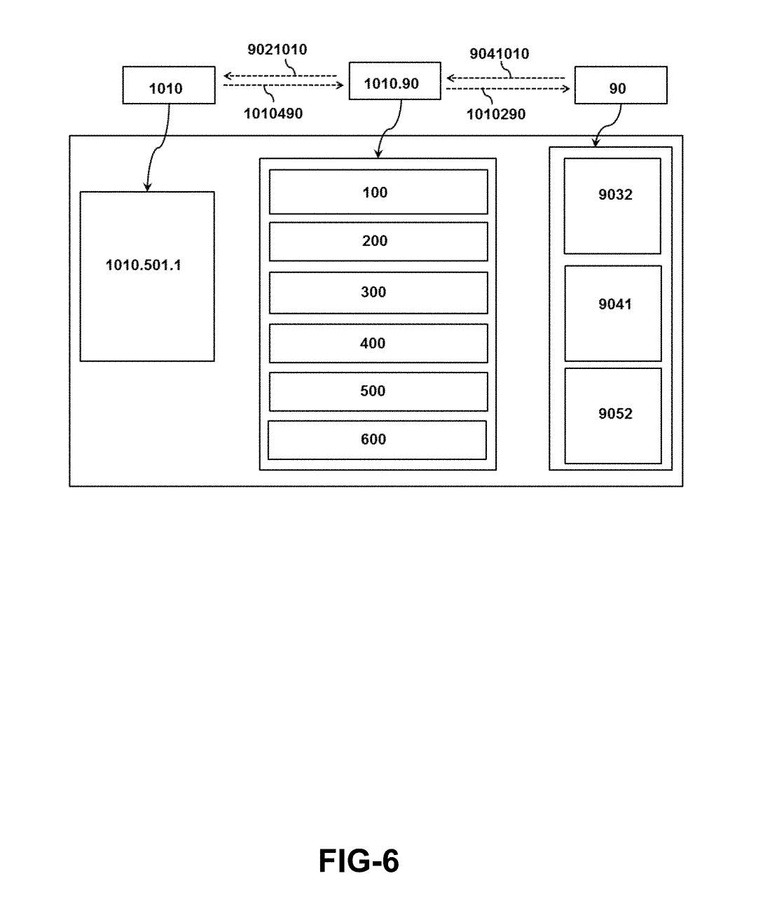

Reference is now made to FIG. 6 which lists the various categories of notifications comprising a perception-based notification file and as shown in FIG. 6 the perception-based notification file is referenced through label 1010.90. The notification category label 200 refers to perception outputs and in preferred embodiments 200 would form the core element of any perception-based notification file. In some embodiments, 1010.90 would be provisioned for transmission from any 1010 such as 1010.501.1 to any connected-autonomous vehicle. As shown in FIG. 6 the label 90 collectively refers to various types of connected-autonomous vehicles, and 90 includes; 9032, 9041 and 9052. The provisioning of 1010.90, from any 1010 to any of the vehicles referenced as 90, is referenced in FIG. 6 through label 1010490. Thereafter, any such provisioned 1010.90 could be transmitted via any device or any system mediation to any of the vehicles referenced as 90 and this transmission is referenced in FIG. 6 through label 1010290. In preferred embodiments, 1010.90 would be provisioned multiple times during one second. In other embodiments, 1010.90 would be communicated by any of the vehicles referenced as 90 to any component device or system within the system of the invention, for onward transmission to any 1010 such as 1010.501.1 for example, and as shown, this communication is referenced in FIG. 6 through label 9041010. The onward communication of 1010.90 from any component device or system within the system of the invention to any 1010 is referenced in FIG. 6 through label 9021010.

The notification category label 100 in FIG. 6 refers to contextual tags. The notification category label 300 refers to any perception feed itself, which could be for example; one or more images, a part of a pointcloud file, or any instance of stereo depth data. The notification category label 400 refers to position data (precise position and orientation relative to the scene) of any originator of any 1010.90. The notification category label 500 refers to orientation data of any vision-perception sensor used by any originator of 1010.90 (and this could include any details about the intrinsic parameters of the vision-perception sensor as well). The notification category label 600 refers to geo-location data in terms of three-dimensional location coordinates in the world coordinate-frame of the vision-perception sensor used by any originator of 1010.90.

In some embodiments, the notification category 100 would itself comprise various different types of contextual tags, (that could be variously assigned to any 1010.90) using any nomenclature, and could be as any; semantic category tags or any state descriptors, and in some embodiments the contextual tags could describe or label any weather parameters affecting any part of the pre-determined physical space. In some embodiments, some of these contextual tags would describe or label the statistical confidence level of any of the detections as being encoded within any of the perception outputs. In other embodiments, some of these contextual tags would describe or label a two-dimensional, grid congestion level arising due to the occupancy of any part of the pre-determined physical space that is being occupied by any number of transient, static obstacles. In some other embodiments, some of these contextual tags would describe or label a two-dimensional, grid congestion level arising due to the occupancy of any part of the pre-determined physical space by any number of transient, moving obstacles. In some embodiments, some of these contextual tags would serve to describe or label any or all of the contents of the perception-based notification file with an associated time stamping of; the generation, the provisioning, the propagation, or the transmission, of the perception-based notification file. In yet other embodiments, some of these contextual tags would be semantic labels describing or labelling (as any form of classification scheme) classifying any of the detections having been encoded and represented through location coordinates within any of the perception outputs. In some embodiments, some of these contextual tags would be describing or labelling any geolocation coordinates identifying the location in the world-coordinate-frame, of any one or more of; any edge position point, of or within the pre-determined physical space, any starting and ending position-points of any extreme boundary edge, of or within the pre-determined physical space, any (representative) corner points of any planar-boundary of the pre-determined physical space region or of any planar-boundary within any part of the pre-determined physical space. In other embodiments, some of these contextual tags would be describing or labelling any geolocation coordinates identifying the location in the world-coordinate-frame of any demarcation-line-segment that may be used as an annotation for demarcating any part of the drivable space or any part of the traversable space from, any permanent structures within any part of the pre-determined physical space. In other embodiments, some of these contextual tags would be labelling or circumscribing the duration of any particular window-of-time, for example a circumscribing window-of-time during which the perception outputs were determined, or during which a perception feed was acquired. In other embodiments, some of these contextual tags would be labelling or circumscribing the duration of any time that may have lapsed between the acquiring of a perception feed and determining of location coordinates (of detected transient, obstacles or detected free-space), as perception outputs pertaining to the pre-determined physical space. In some other embodiments, some of these contextual tags would be providing the frequency (being given as the ‘number of times in one second’) of, the provisioning 1010490, of any 1010.90, occurring within the system of the invention. Also, in some other embodiments, some of the contextual tags comprising 100 may be for providing, the exact or the estimated level of localisation precision being applied to any of the detections of transient objects/obstacles within the pre-determined physical space (and in some embodiments this could be inferred from the level of resolution of data representation being employed for a given perception zone).

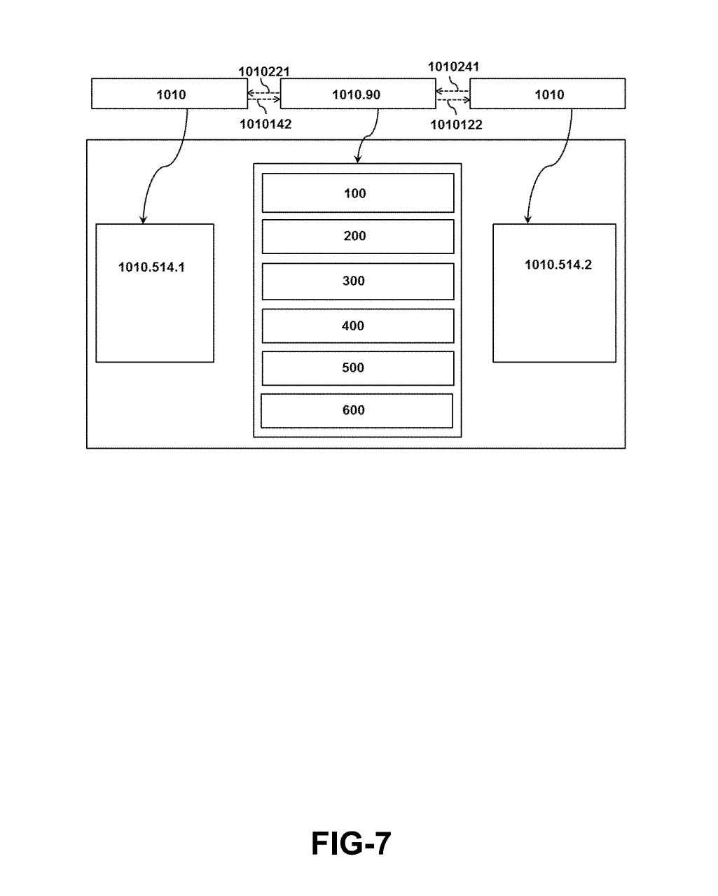

Reference is now made to FIG. 7 which lists the various categories of notifications comprising a perception-based notification file and as shown in FIG. 7 the perception-based notification file is referenced through label 1010.90 and all of the notification category reference labels shown as comprising 1010.90 in FIG. 7 are similar (in their details as well), as described in relation to 1010.90 in FIG. 6 and mean the same things. Also, all of the various different types of contextual tags would be similar as described for 1010.90 in FIG. 6 and would mean the same things as well. It is shown in FIG. 7, that the perception-based notification file 1010.90 could be propagated for transmission to any component, via any device or system mediation, from any 1010 to any other 1010, such as for example, from 1010.514.1 to 1010.514.2. The propagating of 1010.90, from any 1010 such as from 1010.514.1 for any other 1010, is referenced in FIG. 7 through label 1010142. Thereafter, any such propagated 1010.90 could be transmitted via any device or any system mediation to any 1010 being an intended recipient, such as 1010.514.2 as shown in the example case, and this transmission is referenced in FIG. 7 through label 1010122. Similarly, a propagation and transmission in the reverse is also shown. The perception-based notification file 1010.90 could be propagated for transmission to any component via any device or system mediation, from any 1010 such as 1010.514.2 for any other 1010 and this being referenced in FIG. 7 through label 1010241. Thereafter, any such propagated 1010.90 could be transmitted via any device or any system mediation to any 1010 such as 1010.514.1, and this transmission is referenced in FIG. 7 through label 1010221.

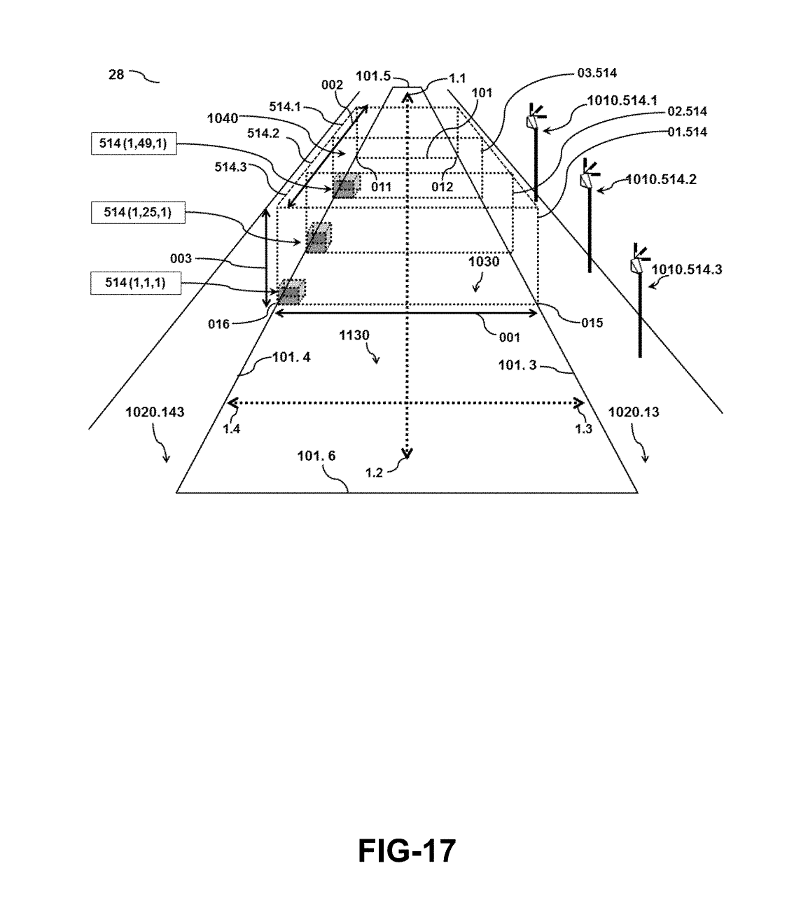

A quick reference to FIG. 17 would assist in understanding the described propagation of a perception-based notification file from one 1010 to another 1010. FIG. 17 shows three perception zones in a geographic zone labelled as 28, and the three perception zones are labelled; 514.1, 514.2 and 514.3. In FIG. 17, three perception masts are also shown labelled as; 1010.514.1, 1010.514.2 and 1010.514.3. In some embodiments, 1010.514.1 would have a vision-perception sensor 600-1010 within itself or upon itself, and this specific 600-1010 may be particularly designated for the purpose of determining perception outputs relating specifically to the perception zone labelled as 514.1. Further, 1010.514.2 would also be having a vision-perception sensor 600-1010 within itself or upon itself, and this specific 600-1010 may be particularly designated for determining perception outputs specifically relating to the perception zone labelled as 514.2. Furthermore, 1010.514.3 would have a vision-perception sensor 600-1010 within itself or upon itself, and this specific 600-1010 may be particularly designated for the purpose of determining perception outputs relating specifically to the perception zone labelled as 514.3.

Given the inherent limitations, of line-of-sight, or limitations of field-of-view, pertaining to a vision-perception sensor, or simply due to the distance involved, it may be the case that the specific 600-1010 within or upon 1010.514.3 may not be having a line-of-sight or field-of-view of the perception zone labelled 514.1 and also be limited in this sense in relation to some portions of the perception zone 514.2. In some embodiments therefore any perception-based notification file 1010.90 created on the basis of the determined perception outputs based on the perception feed acquired from the 600-1010 within or upon 1010.514.1, could be propagated, in order to be onward transmitted via any device or system mediation to 1010.514.2 for example, and there onwards the same 1010.90 could be propagated, in order to be onward transmitted via any device or system mediation to 1010.514.3. In some disclosed embodiments, this same 1010.90 could be provisioned to any on-coming connected-autonomous vehicle as ‘look-ahead’ perception, even from farther out perception zones that the connected-autonomous vehicle's on-board vision-perception sensors (e.g. any 600-90) could not have perceived in advance, while being a given distance away. Thus, as described with reference to FIG. 6 and FIG. 7, it is disclosed how the system of the invention would interoperate as referenced, between any 1010 and 90, as well as between any 1010 and any other 1010. Similar to ‘look-ahead’ perception, the same interoperation would make possible the provisioning, propagation, transmission etcetera of any type of 1010.90 from around a ‘blind corner’ to any connected-autonomous vehicle, ahead of traversing the ‘blind-corner’ and this would be a type of non-line-of-sight (NLOS) perception and the connected-autonomous vehicle's on-board vision-perception sensors (e.g. any 600-90) could not perceive on their own from around a bend that constitutes a ‘blind turn’.

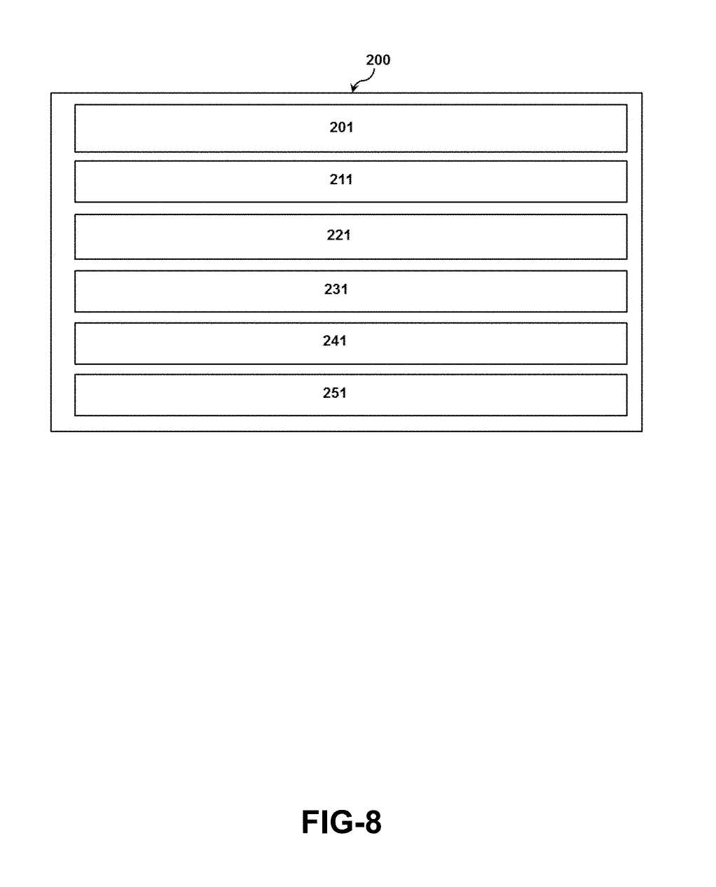

Reference is now made to FIG. 8 which provides a list of data sets comprising the notification category; 200 which refers to perception outputs. As shown in FIG. 8, perception outputs 200 for any given perception zone would comprise data sets labelled; 201, 211, 221, 231, 241 and 251.

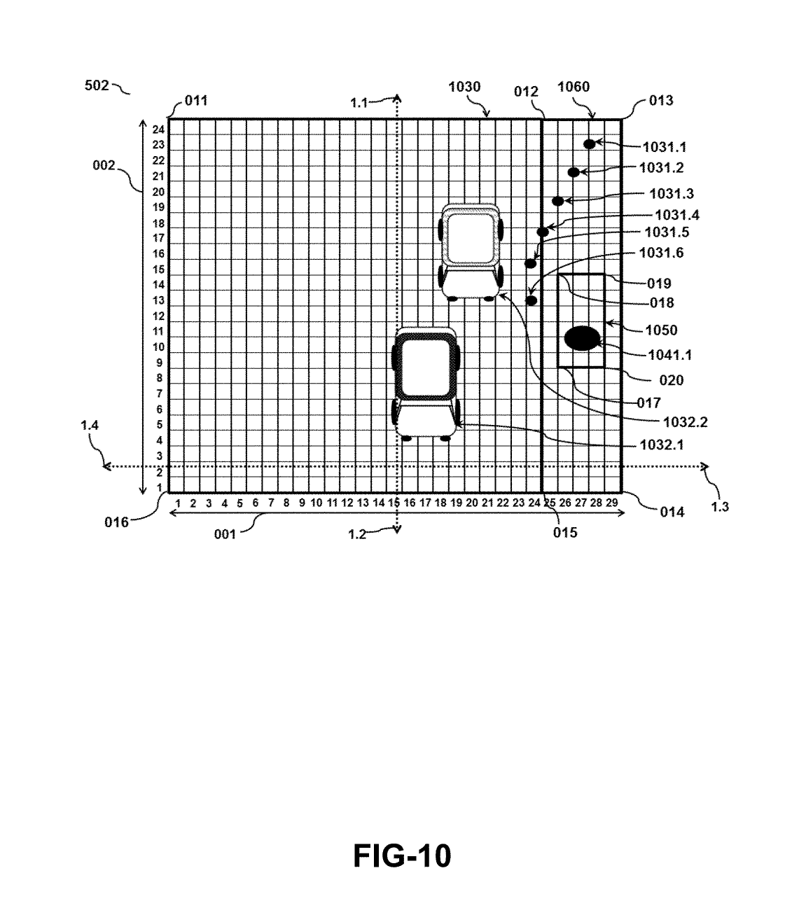

The data set 201 would be a data set pertaining to the system-assigned identities (within the system of the invention) of any one or more transient, static obstacles within a given perception zone, such as for example; 1031.1, as shown upon 1060 in FIG. 10, is a system-assigned identity (to a transient, static obstacle being numbered 1, and, being detected during a particular window of time) within the perception zone 502, and, 1031.5, as shown upon 1030 in FIG. 10 is a system-assigned identity (to a transient, static obstacle being numbered 5, and, being detected during the same particular window of time) within the perception zone 502 as well, and the use of the word transient, in referring to a static obstacle, implies that the static obstacle has been temporarily placed or has become temporarily situated within a perception zone, or within a pre-determined physical space.

Also with reference to FIG. 8, the data set 211 would be a data set pertaining to the system-assigned identities of any one or more transient, moving obstacles, such as for example, 1032.1, as shown upon 1030 in FIG. 10, is a system-assigned identity (to a transient, moving obstacle being numbered 1, and, being detected during the same particular window of time, as has been referred to as the particular window of time, in describing 201 system-assigned identities) within the perception zone 502, and, 1032.2, as shown upon 1030 in FIG. 10 is a system-assigned identity (to a transient, moving obstacle being numbered 2, and, being detected during the same particular window of time) within the perception zone 502. In the context of data set 211, the system would assign such an identity to all detected, transient, moving obstacles wherein these could be any type of moving objects or moving vehicles within a given perception zone, and whether being manually driven or whether autonomously operating, or whether being connected or not being connected. Throughout this disclosure, the use of the word transient, in referring to a moving obstacle implies that the moving obstacle has been detected to have been in a state of motion while within a perception zone, or while within a pre-determined physical space (during a given particular window of time).

Again with reference to FIG. 8, the data set 221 would be a data set comprising; time-stamped (being accordingly time-stamped with reference to the same particular window of time referenced earlier for example, while describing 201 system-assigned identities), and two-dimensionally expressed, position-location coordinates, of each transient, static obstacle, being detected on any part of the drivable space or being detected on any part of the traversable space, within a given perception zone. The position-location coordinates herein would be; the occupancy positions, upon a two-dimensional, grid-representation of the given perception zone, of, the location coordinates, of each transient, static obstacle being detected on any part of the drivable space or being detected on any part of the traversable space, within the given perception zone. Whereas, the location coordinates of the detected obstacles would initially be expressed in the coordinate-frame-of-reference(s) of any relevant and specifically designated vision-perception sensor(s) being designated to operate for the given perception zone. The position-location coordinates herein referred to, can thus accordingly be defined as having been mapped, from the coordinate-frame-of reference(s) of any relevant and specifically designated vision-perception sensor(s), to, the context of the perception-coverage region, and the perception-coverage region herein being represented as a two-dimensional, grid-representation of the given perception zone.

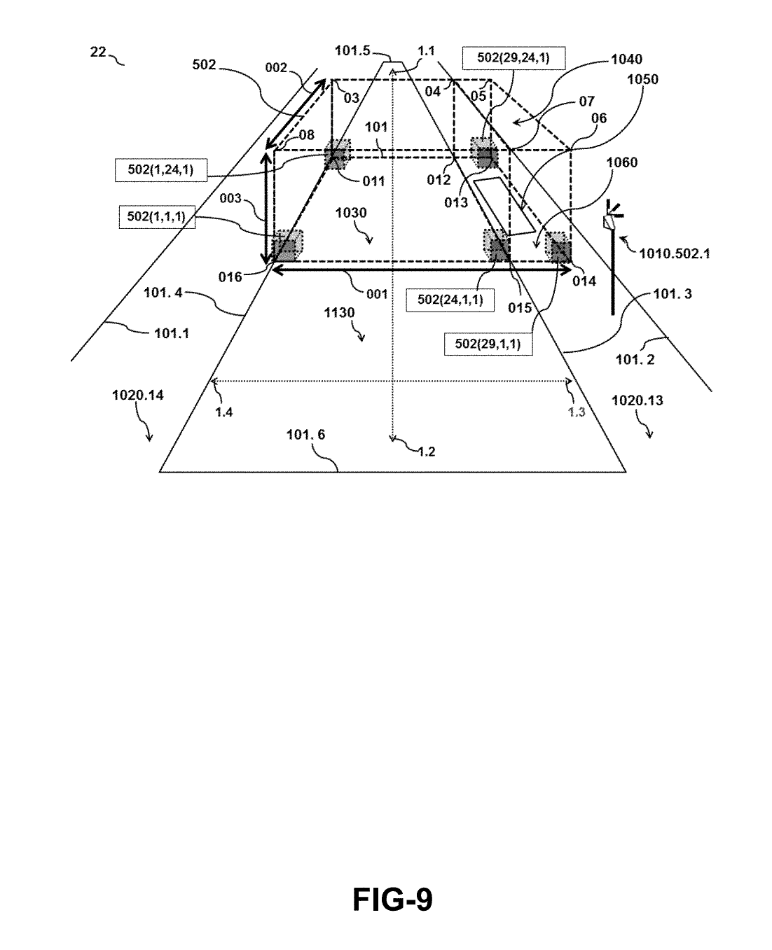

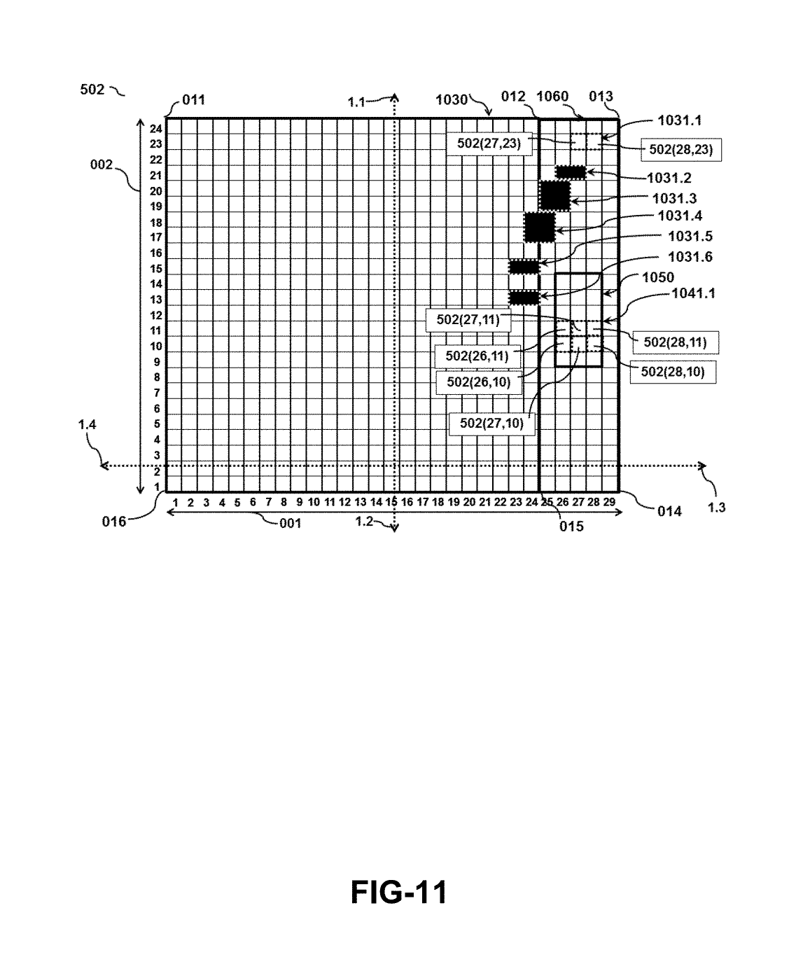

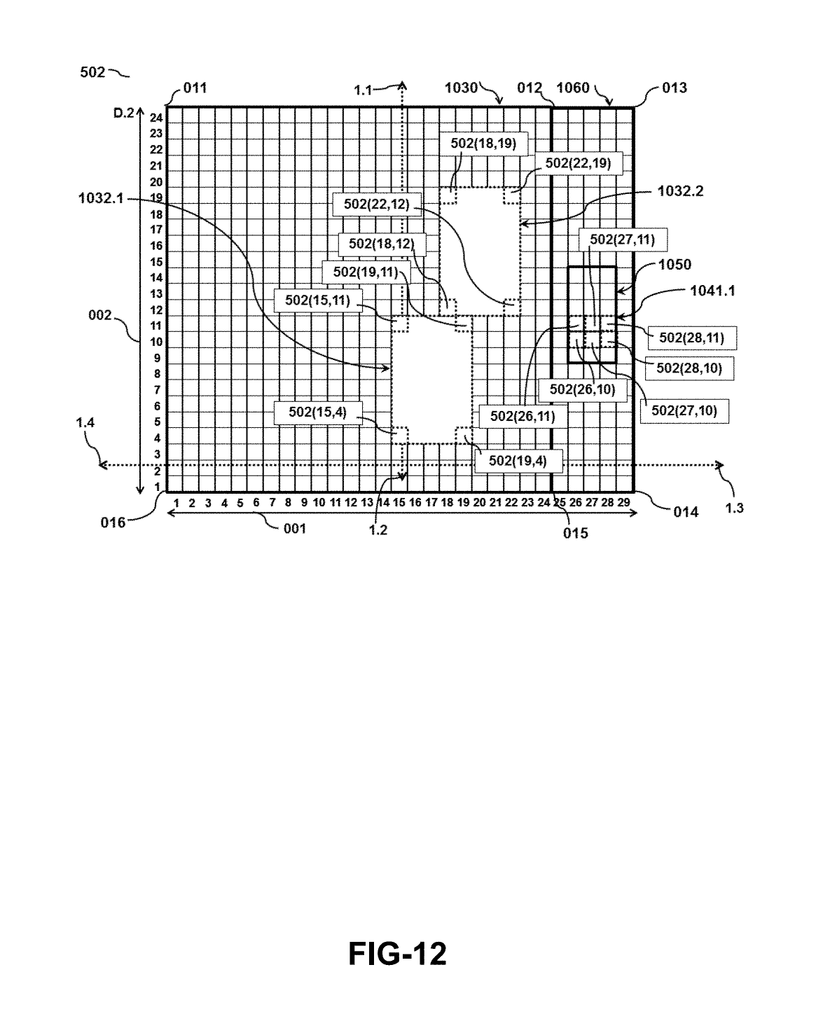

Reference is now made to FIG. 11, which shows a two-dimensional, grid-representation of perception zone 502. (A quick reference to FIG. 9 would assist in visualising the three-dimensional, perspective view, as shown, of 502, which is shown in FIG. 9 as having been established within the geographic zone shown with label reference 22). Referring again to FIG. 11, herein, upon the shown, two-dimensional, grid-representation of 502, the occupancy positions, of all, transient, static obstacles, being detected within 502 during the same particular window of time that has been referenced earlier, are shown with reference labels; 1031.1, 1031.2, 1031.3, 1031.4, 1031.5 and 1031.6. (These reference labels; 1031.1, 1031.2, 1031.3, 1031.4, 1031.5 and 1031.6, are the same system-assigned identities as were shown in FIG. 10 pertaining to these six, transient, static obstacles). As an example, and to elucidate the concept pertaining to data set 221, the position-location coordinates pertaining to the occupancy position of 1031.1 (upon the two-dimensional, grid representation of 502) are shown in FIG. 11 and all occupied grid-square positions being the occupancy positions of 1031.1 are shown with coordinate-labels; 502(27,23) and 502(28,23). Herein the coordinate-label, the term outside the brackets is an identifier referring to the perception zone, and the term within brackets represents coordinate location values expressed in the nomenclature; (‘x’,‘y’) wherein ‘x’ is the coordinate location value along the dimension 001 and ‘y’ is the coordinate location value (of the same position-location) along the dimension 002. Accordingly, for the same particular window of time that has been referenced earlier, the data set 221 would also contain all position-location coordinates pertaining to all occupancy positions of; 1031.2, 1031.3, 1031.4, 1031.5 and 1031.6, (therein being given through all the corresponding grid-square positions reflecting the occupancy position of each of; 1031.2, 1031.3, 1031.4, 1031.5 and 1031.6), similarly as described with reference to 1031.1. In some embodiments, data set 221 would also contain position-location coordinates of any transient, moving obstacles, which may have been found to be in a still state within 502 during, the same particular window of time that has been referenced earlier for example (and this will be duly elaborated in this disclosure, with reference to 1041.1 and with collective reference to; FIG. 11 and FIG. 12).

Again with reference to FIG. 8, the data set 231 would be a data set comprising; time-stamped (being accordingly time-stamped with reference to the same particular window of time referenced earlier for example, while describing 211 system-assigned identities), and two-dimensionally expressed, position-location coordinates, of each transient, moving obstacle, being detected on any part of the drivable space or being detected on any part of the traversable space, within a given perception zone. The position-location coordinates herein would be; the occupancy positions, upon a two-dimensional, grid-representation of the given perception zone, of, the location coordinates, of each transient, moving obstacle being detected on any part of the drivable space or being detected on any part of the traversable space, within the given perception zone. Whereas, the location coordinates of the detected obstacles would initially be expressed in the coordinate-frame-of-reference(s) of any relevant and specifically designated vision-perception sensor(s) being designated to operate for the given perception zone. The position-location coordinates herein referred to, can thus accordingly be defined as having been mapped, from the coordinate-frame-of reference(s) of any relevant and specifically designated vision-perception sensor(s), to, the context of the perception-coverage region, and the perception-coverage region herein being represented as a two-dimensional, grid-representation of the given perception zone.

Reference is now made to FIG. 12, which shows a two-dimensional, grid-representation of perception zone 502. Herein, upon the shown, two-dimensional, grid-representation of 502, the occupancy positions, of all, transient, moving obstacles, being detected within 502 during the same particular window of time that has been referenced earlier, are shown, and therein two such obstacles are shown with reference labels; 1032.1 and 1032.2. (These reference labels; 1032.1 and 1032.2, are the same system-assigned identities as were shown in FIG. 10 pertaining to these two, transient, moving obstacles). As an example, and to elucidate the concept pertaining to data set 231, the position-location coordinates, of some grid-square positions, pertaining to the occupancy position of 1032.1 (upon the two-dimensional, grid representation of 502) are shown in FIG. 12 and these are, four, grid-square positions being at the four corners of the shown occupancy position of 1032.1, and accordingly, these four, grid-square positions are shown with coordinate-labels; 502(15,4), 502(19,4), 502(15,11), and 502(19,11). Herein the coordinate-label, the term outside the brackets is an identifier referring to the perception zone, and the term within brackets represents coordinate location values expressed in the nomenclature; (‘x’,‘y’) wherein ‘x’ is the coordinate location value along the dimension 001 and ‘y’ is the coordinate location value (of the same position-location) along the dimension 002.

Accordingly, for the same particular window of time that has been referenced earlier, the data set 231 would also contain the position-location coordinates, of some grid-square positions, pertaining to the occupancy position of 1032.2, and (similarly as described with reference to 1032.1), four, grid-square positions being at the four corners of the shown occupancy position of 1032.2, are shown with coordinate-labels; 502(18,12), 502(18,19), 502(22,19), and 502(22,12). In some other embodiments, the data set 231 could contain the position-location coordinates of all of the grid-square positions corresponding to the whole of the occupancy position of 1032.1 and 1032.2. As would be apparent to one skilled in the art, in relation to any transient, moving obstacle, being detected, if it's occupancy position is, as shown for example for 1032.1 and 1032.2, of a uniform, rectangular dimension (or even a square dimension), then even just the position-location coordinates, of two, grid-square positions, at two diagonally opposite corner points of the occupancy position would suffice to account for the occupancy position as a whole.

In some embodiments, data set 231 would also contain position-location coordinates of any transient, moving obstacles, which may have been found to be in a still state within 502 during, the same particular window of time being referenced herein. It was stated similarly regarding data set 221, that in some embodiments, 221 would contain position-location coordinates of any transient, moving obstacles, which may have been found to be in a still state within 502 during, the same particular window of time being referenced herein, and it was stated earlier in disclosure that this would be duly elaborated with reference to 1041.1. Proceeding now, therefore, to this elaboration regarding a transient, moving obstacle, which may have been found to be in a still state within, for example, 502, during the same particular window of time being referenced throughout, for the explanations in relation to perception outputs 200.

Referring now to FIG. 10, a reference label 1041.1 is shown. Earlier, with reference to FIG. 4, in relation to 1041, it was stated that 1041 refers to; ‘any aerial drone or other aerial pod or vehicle and it is shown as being a moving aerial vehicle but it is not a connected-vehicle’, and it was also stated; ‘In FIG. 4, as shown, 1041 is within the aerial space above 1060 and, for example as the case may be, 1041 may be coming in to land upon 1050, accordingly 1041 may be also be referred to as a transient, moving obstacle.’ Accordingly, referencing this general description of 1041, we must consider the situation of a special treatment that could be accorded to any 1041 (or to any other type of transient, moving obstacle for that matter), if it was at some later point be found such that it has come to be in a still state while within the perception-coverage region. As shown in FIG. 10, 1041.1 may be used to exemplify the situation mentioned above. Accordingly, consider that 1041.1 would be an aerial drone (for example) that has been previously detected (during some other, previous window of time) as a transient, moving obstacle within 502 and accordingly had been assigned an identity for being such type of an obstacle and therein being serially numbered as ‘1’ among such types of obstacles. Then, during the window of time being referenced throughout for the purpose of elaboration of perception outputs 200, consider that 1041.1 was found to be in a still state. For reasons of being in this state of stillness, which is akin to being a transient, static obstacle, while having the potential to again come into being in a state of motion, it may therefore be pertinent in some embodiments to account for such types of obstacles in both, data set 221 as well as data set 231, till the obstacle reverts to a state of motion and would therefore only be accounted for in data set 231 but no longer be contained in data set 221.

To reflect the state of 1041.1 as being a transient, moving obstacle that is found to be in a still state, it can be noted with reference to FIG. 11 and FIG. 12, that the position-location coordinates of all the grid-square positions reflecting the occupancy position of 1041.1, which are being shown among transient, static obstacles as shown in FIG. 11 as well as being shown among transient, moving obstacles as shown in FIG. 12, in order to elucidate this concept regarding both 221 and 231 in relation to such an obstacle. The position-location coordinates of the grid-square positions corresponding to the occupancy position of 1041.1 within 502 (while during the same particular window of time that has been referenced throughout for elaborating perception outputs 200), are shown in both FIG. 11 and in FIG. 12 with coordinate-labels being given as; 502(26,10), 502(27,10), 502(28,10), 502(26,11), 502(27,11), and 502(28,11).

Continuing, with reference to FIG. 8, the data set 241 would be a data set comprising time-stamped (being accordingly time-stamped with reference to the same particular window of time referenced earlier for elaborating perception outputs 200), two-dimensional position-location coordinates, of any free-space being detected anywhere within the perception-coverage region of a given perception zone. The position-location coordinates herein would be the position-location coordinates of all of the grid-square positions upon a two-dimensional, grid representation of the perception-coverage region of a given perception zone (or a given pre-determined physical space), while excluding; all of the grid-square positions, of the whole of, the occupancy positions, of; all transient, static obstacles, and all transient-moving obstacles (even those being in a still state).

With reference to FIG. 8 again, the data set 251 would be a data set comprising; time stamped (being accordingly time-stamped with reference to the same particular window of time referenced earlier for elaborating perception outputs 200), three-dimensional location coordinates of any part of a free-space being detected anywhere within the perception-coverage region of a given perception zone.

In the context of data set 241 and data set 251, in some embodiments the free-space would be detected directly as would be apparent to one skilled in the art that free-space could be detected through various perception algorithms. In other embodiments, the free-space in the context of data set 241 and data set 251 could be determined by subtracting all of the detections of all detected obstacles from the total available space within a perception zone.

A detailed reference is now made to FIG. 9, which shows a perspective view of a road segment, which is shown in the shape of a trapezoid bounded within edge lines labelled; 101.3, 101.4, 101.5 and 101.6 and 1130 is a label for depicting the drivable surface upon the shown road segment (but which is not within the perception-coverage region). A geographic zone within which this road segment may be situated, is referenced with the label 22. A perception zone 502 is shown with a footprint (of the whole of its base) being exactly upon a pre-determined physical space 101, and 101 being additionally referenced herein as being bounded within four corner points labelled; 011, 013, 014 and 016, and these four corner points also serve as the four corner points of the whole of the base of 502.

A perception mast 1010.502.1 is a first perception mast established to operate for 502. The three dimensions; 001, 002 and 003 are also shown. 1030 is a label for depicting the drivable surface upon the shown road segment, and 1030 is within 502. The other reference labels shown in FIG. 9 that are also shown in FIG. 2 and already described with reference to FIG. 2, have a similar meaning with reference to FIG. 9 and these include; 1040, 1050, 1060, 1.1, 1.2, 1.3, 1.4, 1020.13, 1020.14, 101.1, 101.2, 03, 04, 05, 06, 07 and 08. It is important to note that there is no reference in FIG. 9 to 1070 and this is because 502 does not extend over any part of 1020.14 and in some embodiments this may be the case while establishing a perception zone.

Accordingly, as shown in FIG. 9, 502 has two portions within it. A first portion of 502 can be referenced as being bounded by the eight (representative) corner points labelled; 04, 05, 06, 07, 012, 013, 014 and 015, and, this first portion covers a part of 1020.13 and this first portion accordingly covers a segment of a footpath or of a pedestrian walkway. The ground surface at the base of the first portion within 502 is labelled as 1060. A second portion of 502 can also be referenced as being bounded by eight corner points labelled; 03, 04, 07, 08, 011, 012, 015 and 016, and this second portion covers a part of the road segment itself, the road segment being shown in the shape of a trapezoid bounded within edge lines labelled; 101.3, 101.4, 101.5 and 101.6.

For example, it may be the case that an actual physical measurement of 502 along 001 may be 11.6 meters in terms of the distance when measured from 016 to 014. Also, the case may be that the actual physical measurement of the distance from 016 to 015 may be 9.6 meters; therefore accordingly, the distance from 015 to 014 would be 2 meters (11.6 meters minus 9.6 meters). Also, it may be the case that the measured distance of 502 along 002 may be 9.6 meters as well when measured from 016 to 011 and this measurement is uniform for all parts of 502 along 002. The case may also be that the actual physical measurement of 502 along 003 may be 6 meters.

In some embodiments it may be determined to configure the smaller-cuboids (the smaller-cuboid herein being sub-volume units of 502), such that each smaller-cuboid itself would be 40 centimeters, along each of; 001, 002 and 003. Using the location of 016 as the (representative) point of origin, the first smaller-cuboid would have one of its corners, correspond to the location 016 and this first smaller-cuboid could be assigned any unique identity within 502 and its position-location coordinates as mapped to the three-dimensional context of 502, could be accordingly determined as a coordinate-label; 502(1,1,1). Given the measurement of 502 along 003 being 6 meters, and the measurement of each smaller-cuboid being 40 centimeters in all three dimensions, it would therefore accordingly result in there being 15 smaller-cuboids (6 meters being divided by 40 centimeters) anywhere along the 003 dimension of 502. Also, there would be 24 smaller-cuboids, from 016 to 015 and from 011 to 012 (9.6 meters being divided by 40 centimeters) anywhere along the 001 dimension of 502. Furthermore, there would be 5 smaller-cuboids, from 015 to 014 and from 012 to 013 (2 meters being divided by 40 centimeters) anywhere along 001. Furthermore, there would be 24 smaller-cuboids from 016 to 011 or from 015 to 012 or from 014 to 013 (9.6 meters being divided by 40 centimeters), anywhere along dimension 002 of 502.

A quick reference to FIG. 10 would show the correspondence of the determined scale and described (with reference to FIG. 9) three-dimensional configuration of 502, to the two-dimensional, grid representation of 502 shown in FIG. 10.

Reference is again made to FIG. 9. As referenced earlier, within 502, the first smaller-cuboid could be assigned any unique identity within 502 and the position-location coordinates of the first smaller-cuboid within 502 would accordingly be given by the coordinate-label that reads; 502(1,1,1), (and using 016 as the point of origin with 502). Herein the coordinate-label, the term outside the brackets is an identifier referring to the perception zone, and the term within brackets represents coordinate location values expressed in the nomenclature; (‘x’,‘y’,‘z’) wherein ‘x’ is the coordinate location value along the dimension 001, ‘y’ is the coordinate location value (of the same position-location) along the dimension 002, and ‘z’ is the coordinate location value (also of the same position-location) along the dimension 003. Accordingly, the coordinate-label 502(1,1,1) that labels the smaller-cuboid as shown, is indicative of the position-location coordinates that can be used to reference that part of the volumetric space of 502, which corresponds to the volumetric space being occupied by the smaller-cuboid, as shown (and the volumetric space of the smaller-cuboid, as having been determined in this case, is 40 centimeters along; 001, 002 and 003).

Accordingly, herein, the first smaller-cuboid, shown with coordinate-label 502(1,1,1) is the first smaller-cuboid within 502 and its position-location coordinates (as shown through the coordinate-label) would reference the first discrete position along each of the three dimensions, i.e.; along 001 given by the ‘x’ value, along 002 given by the ‘y’ value, and along 003 given by the ‘z’ value. Another smaller-cuboid within 502 is shown with the coordinate-label that reads 502(1,24,1) and this smaller-cuboid could also be assigned a unique identity within 502 as well, and its position-location coordinates would reference the discrete position as shown in FIG. 9, and its position-location being such that this particular smaller-cuboid would have one of its corners at the exact location of the (representative) corner point 011, of 502.

Accordingly, a total of ‘ten thousand four hundred and forty’ smaller-cuboids (10,440=24×29×15), and each smaller-cuboid being of dimensions 40 centimeters in all three dimensions; 001, 002 and 003, and each having its own unique identity within 502, and each with its own unique position-location within 502 (as given by its own unique position-location coordinates), therein, the unique identity (or the unique coordinate-label) of any of the smaller-cuboids could be utilised, to reference within the context of the three-dimensional, perception-coverage region of 502, the location of any detection of any type of obstacle as being made in the coordinate-frame-of-reference of the vision-perception sensor 600-1010 in 1010.502.1, (having performed a coordinate-transform, as would be apparent to one skilled in the art).

Again with reference to FIG. 9, it can be clarified that having configured a perception zone such as 502, with the dimensional scale (and accordingly the volumetric space) of smaller-cuboids being determined, for example as shown at 40 centimeters cubed, and using 10,440 smaller-cuboids within a physically measured space of; 11.6 meters by 9.6 meters by 6 meters, any detection within 502, after having performed a coordinate-transform from the coordinate-frame-of-reference of any 600-1010 in 1010.502.1 to the three-dimensional coordinate system of 502, produces a suitably precise level of resolution of data representation in some embodiments. All preferred embodiments would adhere to a level of resolution of data representation such that the determined dimensional scale of any smaller-cuboids results in the volumetric space of any of the smaller-cuboids being smaller than one meter cubed (and accordingly the area of the grid-squares being smaller than one meter squared in the corresponding two-dimensional, grid representation as well).

Autonomous vehicle applications would require high levels of resolution of data representation as this would directly impact the achieved level-of-localisation of the detections, subsequently, when the position-location coordinates expressed in the coordinate-frame-of-reference of any perception zone or of any pre-determined physical space, are thereafter transformed (through a second coordinate-transform) into a coordinate-frame-of-reference relevant to the autonomous vehicle. Thus in the most preferred embodiments, the highest possible level of resolution of data representation, that could be achieved given the perception outputs, as the case may be, should be employed.

In preferred embodiments, using smaller-cuboids, each being of dimensions ranging between; 10 centimeters along each of; 001, 002 and 003, to, 40 centimeters along each of; 001, 002 and 003, would work ideally for most conceived applications of the invention, and therefore, not determining the dimensions of any smaller-cuboids to exceed 80 centimeters along each of; 001, 002 and 003, until and unless, the requirements of any specific use case explicitly require and/or permit, a low level of localisation precision of the detections.

To complete the description of FIG. 9, three other discrete position-locations, are shown with coordinate-labels; 502(29,24,1) which is the position-location of a smaller-cuboid with one of its corners corresponding to 013, and 502(29,1,1) which is the position-location of a smaller-cuboid with one of its own corners corresponding to 014, and 502(24,1,1) which is the position-location of a smaller-cuboid with one of its corners corresponding to the 015.

FIG. 10 is a two-dimensional, grid-representation of the perception zone 502, that has been shown earlier in FIG. 9 and therein explained in detail with reference to FIG. 9. As shown in FIG. 9, 502 was shown during some window of time during which, 502 had no transient, obstacle within it. Herein with reference to FIG. 10, the situation of various types of transient, obstacles (including transient, static obstacles and transient, moving obstacles) being within 502, during another window of time (and this window of time being the particular window of time which is being referenced throughout this disclosure with respect to explaining regarding perception outputs 200), is being shown. In accordance with the description of the physical measurements determined for 502, as well as the physical measurements of each smaller-cuboid being determined as 40 centimeters cubed, as described earlier with reference to FIG. 9, accordingly, each grid-square (i.e. each smaller square) within the two-dimensional, grid-representation of 502, as shown in FIG. 10, would measure 40 centimeters square, i.e. be 40 centimeters along the dimension 001 of 502, as well as be 40 centimeters along the dimension 002 of 502.

Also accordingly, as being shown in FIG. 10, in the physical measurement from 016 to 011, along 002, would be 9.6 meters and the physical measurement from 016 to 015, along 001, would also be 9.6 meters. Furthermore, and accordingly as well, the physical measurement from 015 to 014, along 001, would be 2 meters. Thus, accordingly, a total of ‘six hundred and ninety six’ grid-squares would result in the two-dimensional, grid-representation of 502 (and 696 grid-squares being calculated as; 29 grid-squares along 001 being multiplied by 24 grid-squares along 002). In some embodiments, each grid-square would be assigned a unique identity within 502 and each grid-square would also have its own unique position-location coordinates within 502.

Also 1050 is as described earlier and, as shown in FIG. 10, it can be seen that 1050 is bounded by four (representative) corner points labelled as; 017, 018, 019 and 020. Also 1030 is as described earlier, and as shown in FIG. 10, it can be seen that 1030 is bounded by four (representative) corner points labelled as; 011, 012, 015 and 016. Furthermore, 1060 is as described earlier, and as shown in FIG. 10, it can be seen that 1060 is bounded by four (representative) corner points labelled; 012, 013, 014 and 015. For the purpose of determining the two-dimensional position-location coordinates of each grid-square, 016 serves as the point of origin.

In both FIG. 9 and in FIG. 10, a first orientation-axis is marked at one end with label 1.1 at the first arrowhead and at the other end with the label 1.2 at the second arrowhead, and the lateral orientation of the road segment is depicted through a second orientation-axis which is marked at one end with label 1.3 at the first arrowhead and at the other end with the label 1.4 at the second arrowhead. 1010.502.1 as was shown in FIG. 9 is not explicitly shown in FIG. 10 but the same 1010.502.1 (and implying the same functionality), is to be inferred, and is therefore an applicable reference in the context of FIG. 10 as well as in the context of FIG. 11 and FIG. 12 though not explicitly shown in the ‘top-down’ views shown in; FIG. 10, FIG. 11 and FIG. 12.

At various particular instances of time (and any instance of time being circumscribed as, a window of time and therefore referred to as a window of time), various types of vehicles could be passing through 502 or various objects could be placed or could have come to be located within 502 as the case may be, or 502 may be empty during other windows of time. In preferred embodiments, any particular instance of time would be circumscribed as a window of time that is no longer than a one-second window of time.

Herein with reference to FIG. 10, the situation of various types of transient, obstacles being within 502, during the particular window of time which is being referenced throughout this disclosure with respect to explaining regarding perception outputs 200, is shown with reference to their system-assigned identities. For example, the system-assigned identities of six, (as shown to be present), transient, static obstacles, are shown as labels; 1031.1, 1031.2, 1031.3, 1031.4, 1031.5 and 1031.6 and these are a; first, second, third, fourth, fifth and sixth transient, static obstacle, respectively. Also, the system-assigned identities of two, (as shown to be present), transient, moving obstacles, are shown as labels; 1032.1 and 1032.2, and these are a; first and a second, transient, moving obstacle, respectively. Also, the system-assigned identities of one other, (as shown to be present), transient, moving obstacle, that may (for example) have come to be in a still state, is shown through the label; 1041.1, and this would be a first transient, moving obstacle, that may (for example) have come to be in a still state. As shown in FIG. 10, 1032.1 and 1032.2, are shown to be road vehicles in motion, and these are not connected-vehicles and are manually driven cars for instance, that are at, the location as shown, while passing over 1030 of 502. Also, as shown in FIG. 10, 1041.1, is shown to be aerial drone for instance, and it is not a connected-vehicle and is a manually operated aerial drone), that is at, the location as shown, being in a state of stillness (e.g. hovering ‘in position’ without there being a perceptible change in detected location) over 1050 of 502. Further also, as shown in FIG. 10, the six, transient, static obstacles; 1031.1, 1031.2, 1031.3, 1031.4, 1031.5 and 1031.6, are shown to be traffic cones for instance, and two of these traffic cones (1031.5 and 1031.6) are shown as being located upon 1030 of 502, three of these traffic cones (1031.1, 1031.2 and 1031.3) are shown as being located upon 1060 of 502, and one traffic cone (1031.4) is shown straddling the boundary of 1060 and 1030.

Reference is now made to FIG. 11 and FIG. 11 is a two-dimensional, grid-representation (being a type of a two-dimensional, grid occupancy map), of the perception zone 502. In FIG. 11, the occupancy positions of all of the, transient, static obstacles (as during the particular window of time referenced throughout this disclosure to elaborate regarding perception outputs 200) are shown using the same labels as shown for the system-assigned identity of each obstacle in FIG. 10. Herein the occupancy positions of; 1031.2, 1031.3, 1031.4, 1031.5 and 1031.6 are shown (and simply to elucidate the point, as being filled in black) upon the two-dimensional, grid-representation. For example, 1031.6 as shown in FIG. 10, can be seen to occupying a portion of two grid-squares and the position-location of these two grid-squares could be read off (the coordinate-labels of any position-locations are not explicitly labelled in FIG. 10) from the two-dimensional, grid-representation shown in FIG. 10 and these position-locations would correspond to the coordinate-labels; 502(23,13) and 502(24,13). Cross-referencing with FIG. 11 it can be seen that the assigned occupancy of 1031.6 as shown in FIG. 11 is position-location of these same two grid-square positions. In FIG. 11, the position-location of the two, grid-squares comprising the whole of the occupancy position of 1031.1 (which for clarity of showing both grid-squares has not been filled in black) are shown with coordinate-labels; 502(27,23) and 502(28,23).

In some embodiments, data set 221 would comprise all of the position-location coordinates (and therein all of the coordinate-labels) corresponding to the occupancy position of all of the transient, static obstacles; 1031.1, 1031.2, 1031.3, 1031.4, 1031.5 and 1031.6. In other embodiments, instead of this, data set 221 could be comprising, only the unique identities of the grid-squares, corresponding to, all of the position-location coordinates in turn corresponding to the occupancy position of all of the transient, static obstacles; 1031.1, 1031.2, 1031.3, 1031.4, 1031.5 and 1031.6. As would be apparent to one skilled in the art, the data file size being smaller, if low communication bandwidths were to constrain any notification file size, therein reducing the file size in this way, could contribute to faster data transmission. In some embodiments, data set 221 would also comprise all of the position-location coordinates (and therein all of the coordinate-labels) corresponding to the occupancy position of any transient, moving obstacle, such as 1041.1, that has come to be in a still state, and as shown in FIG. 11, the position-location coordinates corresponding to the occupancy position of 1041.1 within 502 could be referenced through coordinate-labels; 502(26,10), 502(27,10), 502(28,10), 502(26,11), 502(27,11) and 502(28,11). In other embodiments, instead of this, data set 221 could be comprising, the unique identities of the grid-squares, corresponding to, all of the position-location coordinates in turn corresponding to the occupancy position of any transient, moving obstacles (such as 1041.1) that may have come to be in a still state. As would be apparent to one skilled in the art, if a different set of measurements were to be determined for the smaller-cuboids within 502, for example determining that each smaller-cuboid would be larger than or smaller than the determined 40 centimeters along each of; 001, 002 and 003, as in this case, then accordingly the occupancy positions within 502, of the various obstacles would be referenced differently, due to any different level of resolution of data representation being determined through that choice.

Reference is now made to FIG. 12 and FIG. 12 is a two-dimensional, grid-representation (being, another type of a grid occupancy map), of the perception zone 502. In FIG. 12, the occupancy positions of all of the, transient, moving obstacles (as during the particular window of time referenced throughout this disclosure to elaborate regarding perception outputs 200) are shown using the same labels as shown for the system-assigned identity of each obstacle in FIG. 10. Herein the occupancy positions of; 1032.1 and 1032.2 are shown (and simply to elucidate the point, the occupancy position of each being filled in white and the occupancy position including as well the four white grid-squares at the four corners as shown with accompanying coordinate-labels) upon the two-dimensional, grid-representation. For example, 1032.1 as shown in FIG. 10, can be seen to occupying some portion of or all of, a total of 40 grid-squares, and the position-location of these 40 grid-squares could be read off (the coordinate-labels of any position-locations are not explicitly labelled in FIG. 10) from the two-dimensional, grid-representation shown in FIG. 10. As would be apparent to one skilled in the art, the occupancy position of 1032.1 could be readily conveyed through just four of the grid-squares at the four corners of the occupancy position, and the position-locations of these four grid-squares at the four corners of the occupancy position could be given, as shown in FIG. 12, through the coordinate-labels; 502(15,4), 502(19,4), 502(15,11), and 502(19,11). Also, 1032.2 as shown in FIG. 10, can be seen to occupying some portion of or all of, a total of forty grid-squares, and the position-location of these 40 grid-squares could be read off (the coordinate-labels of any position-locations are not explicitly labelled in FIG. 10) from the two-dimensional, grid-representation shown in FIG. 10. As would be apparent to one skilled in the art, the occupancy position of 1032.2 could be readily conveyed through just four of the grid-squares at the four corners of the occupancy position, and the position-locations of these four grid-squares at the four corners of the occupancy position could be given, as shown in FIG. 12, through the coordinate-labels; 502(18,12), 502(22,12), 502(18,19), and 502(22,19).

In some embodiments, data set 231 would comprise all of the position-location coordinates (and therein all of the coordinate-labels) corresponding to the occupancy position of all transient, moving obstacles, e.g. of; 1032.1 and 1032.2. In other embodiments, instead of this, data set 231 could be comprising, only the unique identities of the grid-squares, corresponding to, all of the position-location coordinates in turn corresponding to the occupancy position of all of the transient, moving obstacles, being; 1032.1 and 1032.2. In some embodiments, data set 231 would also comprise all of the position-location coordinates (and therein all of the coordinate-labels) corresponding to the occupancy position of any transient, moving obstacle, such as 1041.1, that has come to be in a still state, and as shown in FIG. 12 (and also shown earlier in FIG. 11), the position-location coordinates corresponding to the occupancy position of 1040.1 within 502 could be referenced through coordinate-labels; 502(26,10), 502(27,10), 502(28,10), 502(26,11), 502(27,11) and 502(28,11). In other embodiments, instead of this, data set 231 could be comprising, the unique identities of the grid-squares, corresponding to, all of the position-location coordinates in turn corresponding to the occupancy position of any transient, moving obstacles (such as 1041.1) that may have come to be in a still state.

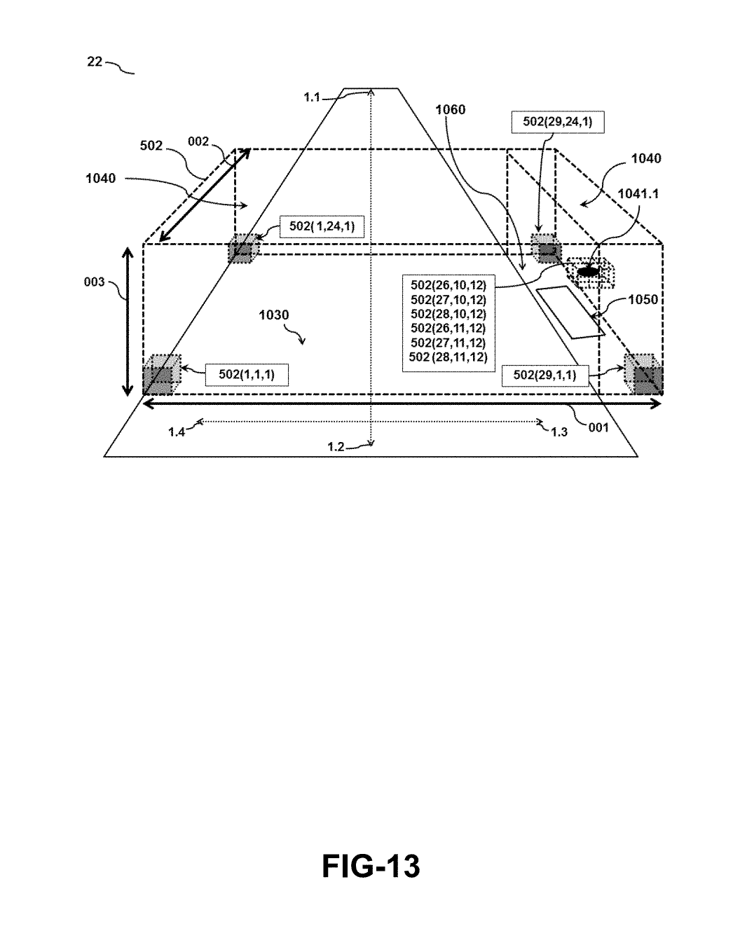

Reference is now made to FIG. 13 which now shows a close up perspective view of the exact same perception zone 502 within 22, as was shown earlier in FIG. 9. All of the references and labels which are shown and described earlier with reference to FIG. 9 are to be inferred as being applicable to FIG. 13 and mean the same, even though not being explicitly shown as references or labels within FIG. 13. Also, accordingly 1010.502.1 is to be inferred as being present and operative for 502 in reference to FIG. 13, though 1010.502.1 is not shown in the close up perspective view of 502 shown in FIG. 13.

With reference to FIG. 13 it can be explained how the position-location coordinates of a transient, moving obstacle (that has come to be in a still state) could be expressed as three-dimensional position-location coordinates within the context of a perception zone. For this we now consider a particular window of time, which we call a new window of time, and during this new window of time, all of the transient, static obstacles; 1031.1, 1031.2, 1031.3, 1031.4, 1031.5 and 1031.6, have been removed and also, the transient, moving obstacles; 1032.1 and 1032.2 have already vacated 502.

As shown in FIG. 13, it is to be inferred that 1041.1 is the only obstacle currently within 502 during the new window of time and 1041.1 is a transient, moving obstacle that is in a still state (even during the new window of time) (as the case may be while hovering at a spot without undergoing any change in the location coordinates). The position-location coordinates, corresponding to the occupancy position as shown of 1041.1 within 502 can be expressed in terms of the coordinate-labels of the smaller-cuboids within 502 corresponding to the occupancy position of 1041.1 within 502, and these would be referenced through the coordinate-labels; 502(26,10,12), 502(27,10,12), 502(28,10,12), 502(26,11,12), 502(27,11,12), and 502(28,11,12).

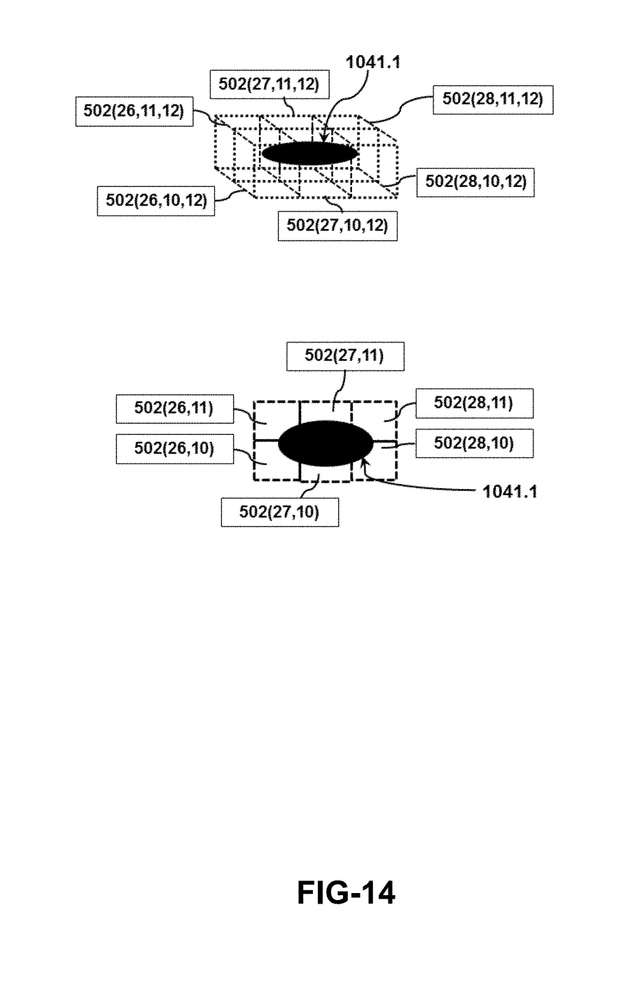

Reference is now made to FIG. 14, in which the position-location coordinates of the occupancy position of 1041.1 within 502 during the new window of time, are shown as being expressed in terms of, both, three-dimensional position-location coordinates as well as two-dimensional position-location coordinates.

The position-location coordinates pertaining to the occupancy position of 1041.1 within 502 during the new window of time, expressed three-dimensionally, can be given by the coordinate-labels; 502(26,10,12), 502(27,10,12), 502(28,10,12), 502(26,11,12), 502(27,11,12), and 502(28,11,12), and expressed two-dimensionally, can be given by the coordinate-labels; 502(26,10), 502(27,10), 502(28,10), 502(26,11), 502(27,11), and 502(28,11).

In some embodiments, 231 would comprise three-dimensionally expressed position-location coordinates (of transient, moving obstacles), either in addition to two-dimensionally expressed position-location coordinates (of transient, moving obstacles), or as an alternative to the two-dimensionally expressed position-location coordinates (of transient, moving obstacles). Similarly, in some embodiments, 221 would comprise three-dimensionally expressed position-location coordinates (of transient, static obstacles), either in addition to two-dimensionally expressed position-location coordinates (of transient, static obstacles), or as an alternative to the two-dimensionally expressed position-location coordinates (of transient, static obstacles). Furthermore, in some embodiments, both 221 and 231 would comprise three-dimensionally expressed position-location coordinates (of transient, moving obstacles that may have come to be in a still state), either in addition to two-dimensionally expressed position-location coordinates (of transient, moving obstacles that may have come to be in a still state), or as an alternative to the two-dimensionally expressed position-location coordinates (of transient, moving obstacles that may have come to be in a still state). Accordingly for any various embodiments, in this context, the unique identities of the smaller-cuboids or of the grid-squares (the smaller squares upon a two-dimensional, grid-representation that has been described) may be alternatively be contained within 221 and 231 (alternatively herein meaning alternatively to expressing any position-location through use of any coordinate-labels).

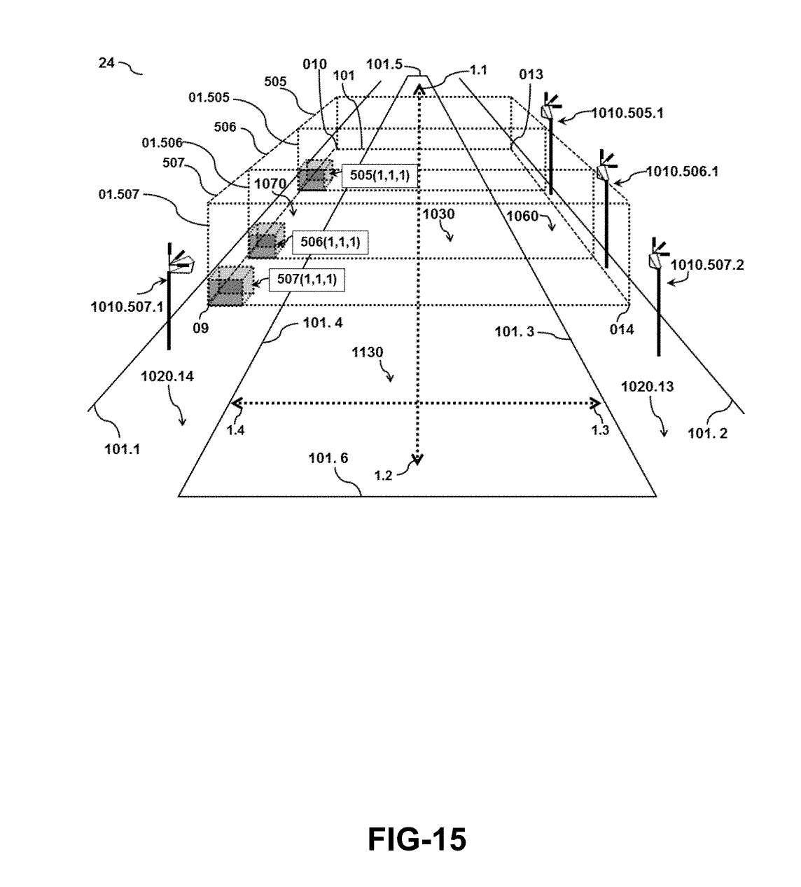

Reference is now made to FIG. 15 which shows a perspective view of a road segment, shown in the shape of a trapezoid bounded within edge lines labelled; 101.3, 101.4, 101.5 and 101.6, and the road segment as shown, is in a geographic zone labelled 24 and therein, upon a determined region 101 within 24, three perception zones; 505, 506 and 507 are shown to been established, and are shown as having a collective footprint, which is the same as, the whole of 101, wherein 101 is a pre-determined physical space and is shown as a region bounded within four corner points labelled; 09, 010, 013 and 014.

Four numbered perception masts are shown as being operative; 1010.505.1 being a first perception mast and is operative for 505, and 1010.506.1 being a second perception mast as being operative and this is operative for 506, and also 1010.507.1 and 1010.507.2 are respectively a first and a second perception mast being operative for 507.

FIG. 15 shows how, in some embodiments, a three-dimensional, grid occupancy map could be constructed. Even though, as shown; 505, 506 and 507, have been established contiguously upon 101, but that the data representation scheme within each perception zone could be determined so as to operate independently within each perception zone with respect to representing the data pertaining to the perception zone. As shown, the geographic orientation is the same for 505, 506 and 507 as shown by the first orientation-axis labelled at one of its arrowheads with label 1.1 and at the other one of its arrowheads with label 1.2. Similarly, the lateral orientation is shown by the second orientation-axis labelled at one of its arrowheads with label 1.3 and at the other one of its arrowheads with label 1.4. In some embodiments it may be the case that the physical dimensions of the perception zones such as; 505, 506 and 507 may also be exactly the same as well and this is exactly what is to be inferred as being shown with reference to FIG. 15 as well. Each of; 505, 506 and 507, cover a portion of the road segment and also cover a portion of 1020.13 and also cover a portion of 1020.14. The three dimensions; 001, 002 and 003 (though not explicitly labelled herein within FIG. 15) are to be inferred as being applicable to each of 505, 506 and 507 and having the same meaning herein as well, as described throughout this disclosure.

With reference to FIG. 15, 01.507 is a first entry face of 507 and 01.507 is a vertically oriented representational plane of 507 with its base being oriented along 001 (i.e. from 09 to 014). Also, 01.506 is a first entry face of 506 and 01.506 is a vertically oriented representational plane of 506 and its base is also oriented along 001 (and the bases of both 01.506 and 01.507 are shown to be parallel). Further, 01.505 is a first entry face of 505 and 01.505 is a vertically oriented representational plane of 505, with its base also being oriented along 001 as well and being parallel to the bases of both 01.506 and 01.507.

As shown in FIG. 15, 1030, 1060 and 1070 would have similar meaning as described elsewhere in this disclosure. In FIG. 15, 1030 is shown with the aid of a reference label for 1030 within 506, and 1060 as shown as a reference label within 506, and, 1070 as shown is as a reference label within 506. Accordingly, though not expressly shown or labelled, 505 and 507 would also have their own distinct 1030, 1060 and 1070.

In some embodiments, as shown with reference to FIG. 15, the data representation scheme for 507 would operate between 01.507 and 01.506. Also, the data representation scheme for 506 would operate between 01.506 and 01.505. Further, the data representation scheme for 505 would operate between 01.505 onwards along 002 up to the edge boundary of 101, as moving towards the direction; 1.1 of the first orientation-axis).

Therein within the ranges indicated, the data representation scheme of each perception zone would begin at the origin of each perception zone and end within the same perception zone. Accordingly, in some embodiments, determining the (representative) corner point 09 as the point of origin of 507, then, the coordinate-label 507(1,1,1) would give the position-location coordinates of the first smaller-cuboid of 507 and represent the first discrete position-location within 507 as shown. Accordingly, as shown, the coordinate-label 506(1,1,1) would give the position-location coordinates of the first smaller-cuboid of 506 and represent the first discrete position-location within 506 as shown. Also, 505(1,1,1) would give the position-location coordinates of the first smaller-cuboid of 505 and represent the first discrete position-location within 505 as shown.

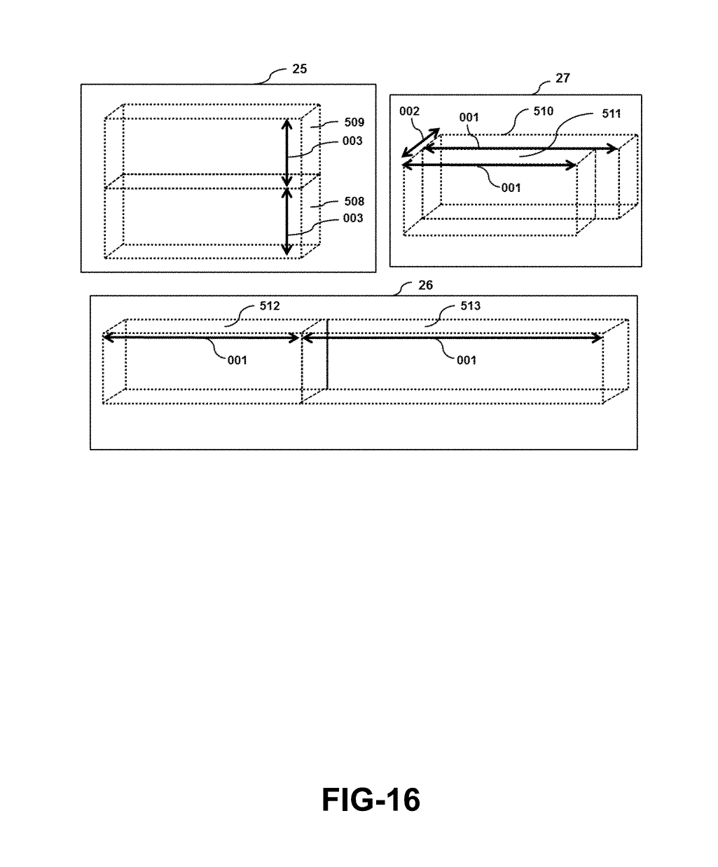

Reference is now made to FIG. 16. In some embodiments, as can be shown with reference to box labelled 25, two perception zones; 509 and 508, which may both have the exact same physical dimensions, may be established contiguously, one above the other and be aligned, contiguously above each other along the dimension 003. In some embodiments, the physical dimensions of such perception zones, being contiguously above each other along the dimension 003 may be unequal, along any dimension. In some other embodiments, as shown in box labelled 27, two perception zones; 510 and 511, being of different physical dimensions along the dimension 001, may be established contiguously. Also, in some other embodiments, as the case may require for various configurations of road segments at junctions for example, two or more perception zones of equal or unequal physical dimensions may be established contiguously, as shown in box labelled 26 in which two perception zones; 512 and 513 are shown contiguously aligned along the dimension 001. As the case may, various situations that require perception zones of unequal dimensions to be established upon sections of various road segments, or elsewhere, therein such cases, it would be that the data representation scheme within each perception zone may need to be determined so as to operate independently within each perception zone with respect to representing the data pertaining to each perception zone. Also, where the road width for example, changes, that is, being different in physical measurement, in the lateral orientation (as given by the orientation of the second orientation-axis), therein as well, contiguously established perception zones may need to be determined as being of different measurement along 001 and therein as well, the data representation scheme within each perception zone may need to be determined so as to operate independently within each perception zone, and accordingly the perception zone data representation scheme may need to be determined as described with reference to FIG. 15.

Reference is now made to FIG. 17, which shows a perspective view of a road segment, shown in the shape of a trapezoid bounded within edge lines labelled; 101.3, 101.4, 101.5 and 101.6, and the road segment as shown, is in a geographic zone labelled 28 and therein, a set of perception zones, comprising three, contiguously established perception zones; 514.1, 514.2 and 514.3, could be referenced, for an explanation of how another type of three-dimensional, grid occupancy map could be constructed. As shown, the base of this set of perception zones, occupies the exact footprint of the pre-determined physical space 101, and 101 is shown as being bounded within four (representative) corner points labelled; 016, 011, 012 and 015. In some embodiments, as shown in FIG. 17, a set of perception zones, could be configured to function such that the data representation scheme, operates as, a conjoint data representation scheme, within the whole of the collective region of the set of perception zones (with no independent data representation scheme operating within each perception zone within the set).

As shown in FIG. 17, 1010.514.1 is a first perception mast and it is shown as being operative for 514.1, and 1010.514.2 is a second perception mast and it is shown as being operative for 514.2, and also 1010.514.3 is a third perception mast and it is shown as being operative for 514.3. It can be seen that the coordinate-label 514(1,1,1) represents the first discrete position-location, within 514.3 and according to conjoint data representation scheme, the coordinate-label 514(1,1,1) also represents the first discrete position-location within, the set of perception zones, comprising the three contiguously established perception zones labelled; 514.1, 514.2 and 514.3. In some embodiments, the position-location, being ascribed by the coordinate-label 514(1,1,1) would correspond to the point of origin (as having been determined) of the whole of, the set of perception zones, comprising the three contiguously established perception zones labelled; 514.1, 514.2 and 514.3. Accordingly, there would be no further point of origin for any data representation scheme within any of the perception zones within the set of perception zones.

In some embodiments, it may be the case that the perception zones; 514.1, 514.2 and 514.3 may each have been determined with dimensional measurements (of both the perception zone and the smaller-cuboids within), in such a way that, each perception zone may have, twenty-four smaller-cuboids along its dimension 002 and also along its dimension 001. Then accordingly, the coordinate-label 514(1,25,1) would represent, the twenty-fifth discrete position-location (of a smaller-cuboid) along the dimension 002 within the whole of, the set of perception zones. Also accordingly, the coordinate-label 514(1,49,1) would represent the forty-ninth position along the dimension 002 of the whole of, the set of perception zones.

A conjoint data representation scheme as described with reference to FIG. 17, would be particularly useful in the case of, long and straight stretches of road segments, for example along those portion of highways where the road segment follows a uniform vertical orientation along the road (as given by the first orientation-axis) as well as a uniform lateral orientation (as given by the second orientation-axis).

As shown in FIG. 17, the geographic orientation (i.e. the vertical orientation along the length of the road segment) is the same for 514.3, 514.2 and 514.1 as shown by the first orientation-axis labelled at one of its arrowheads with label 1.1 and at the other one of its arrowheads with label 1.2. Similarly, the lateral orientation is shown by the second orientation-axis labelled at one of its arrowheads with label 1.3 and at the other one of its arrowheads with label 1.4. The three dimensions; 001, 002 and 003 are shown in FIG. 17 and have the same meaning as described throughout this disclosure. 01.514 is the a first entry face of the whole of, the set of perception zones comprising the three contiguously established perception zones labelled; 514.1, 514.2 and 514.3 and 01.514 is a vertically oriented representational plane with its base being oriented along 001 and 01.514 is also a virtual, planar-boundary of 514.3. Also 02.514 is the second entry face of the whole of, the set of perception zones comprising the three contiguously established perception zones labelled; 514.1, 514.2 and 514.3 and 02.514 is a vertically oriented representational plane with its base being oriented along 001 and 02.514 is a virtual, planar-boundary of 514.2. Lastly, 03.514 is the a third entry face of the whole of, the set of perception zones comprising the three contiguously established perception zones labelled; 514.1, 514.2 and 514.3 and 03.514 is a vertically oriented representational plane with its base being oriented along 001 and 03.514 is a virtual, planar-boundary of 514.1. As shown, this set of perception zones does not cover any portion of 1020.13 or of 1020.14 as shown. As shown in FIG. 17, 1040 refers to the whole of the space above the whole of 1030 within this set of perception zones, comprising the three contiguously established perception zones labelled; 514.1, 514.2 and 514.3. As shown, 1130 is the drivable surface, upon the road segment, which is outside the perception-coverage region of the whole set of perception zones, whereas 1030 is the drivable surface, upon the road segment, which is within the perception-coverage region of the whole of the set of perception zones.

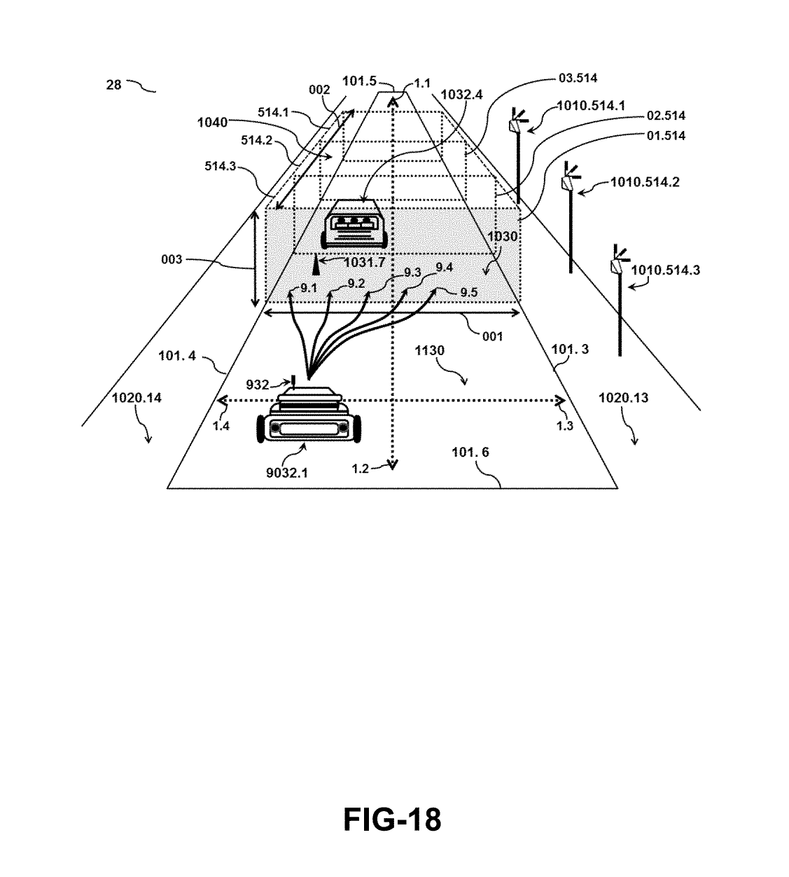

Reference is now made to FIG. 18, and FIG. 18 shows a perspective view of a road segment, shown in the shape of a trapezoid bounded within edge lines labelled; 101.3, 101.4, 101.5 and 101.6, and the road segment as shown, is in a geographic zone labelled 28 and therein, a set of perception zones, comprising three, contiguously established perception zones; 514.1, 514.2 and 514.3, is shown (and this is similar to as shown in FIG. 17). As shown, the base of this set of perception zones, occupies the exact footprint of the pre-determined physical space 101 (as was shown in FIG. 17 through not explicitly shown with reference labels in FIG. 18 to avoid labelling clutter but 101 is to be inferred similarly with reference to FIG. 18), and 101 was shown (in FIG. 17) as being bounded within four (representative) corner points labelled; 016, 011, 012 and 015. In some embodiments, as shown in FIG. 18, a set of perception zones, is shown to have been configured to function such that the data representation scheme, operates as, a conjoint data representation scheme, within the whole of the collective region of the set of perception zones (with no independent data representation scheme operating within each perception zone within the set). All of the references and descriptions shown or described with reference to FIG. 17, are to be inferred as being applicable references and descriptions for FIG. 18, even though all the elements and references from FIG. 17 are not explicitly shown or described herein.

FIG. 18 introduces two obstacles; 1031.7 and 1032.4. As shown, 1031.7 is shown to be a transient, static obstacle, being upon 1030 within 514.3 during some given particular window of time, and during that very same particular window of time, 1032.4 is a transient, moving obstacle upon 1030 within 514.2 being at the position as shown. With knowledge therein, of the position-location coordinates describing the occupancy positions of 1031.7 and of 1032.4, various types of perception-based guidances could be produced for serving as guidances in-advance of approach to the set of perception zones, that could be provisioned to any connected-autonomous vehicle, before the connected-autonomous vehicle implements an autonomous navigation manoeuvre for entering into or for passing through any part of, the set of perception zones, comprising; 514.1, 514.2 and 514.3.

For example, various potential, entry points for entry into 514.3 are shown with labels; 9.1, 9.2, 9.3, 9.4 and 9.5 (and any various potential, entry points such as these could be upon any virtual, planar-boundary of any perception zone). As shown in FIG. 18, the various potential, entry points; 9.1, 9.2, 9.3, 9.4 and 9.5 are upon a virtual, planar-boundary of 514.3 and this virtual, planar-boundary can also be referenced as the entry face 01.514 and it is the first entry face of the set of perception zones comprising the three contiguously established perception zones labelled; 514.1, 514.2 and 514.3.

Accordingly then, with knowledge therein, of the position-location coordinates describing the occupancy positions of 1031.7 and of 1032.4, any of the various potential entry points such as; 9.1, 9.2, 9.3, 9.4 and 9.5, could be declared as being viable and/or un-viable entry points, for the purpose of entering into or for the purpose of traversing through any section or any portion of the any free-space. As shown for example in FIG. 18, 9.1 and 9.2 may be declared as un-viable entry points at 01.514, for entry, into 514.3, at a particular instance of time that is some seconds or some milliseconds (as may be determined), after, the end of the circumscribed duration of the given particular window of time that is being referenced in relation to FIG. 18. Similarly, for example; 9.3, 9.4 and 9.5 may be declared as viable entry points at 01.514, for entry, into 514.3, at a particular instance of time that is some seconds or some milliseconds (as may be determined), after, the end of the circumscribed duration of the given particular window of time that is being referenced in relation to FIG. 18.

Any connected-autonomous vehicle, such as 9032.1 for example, shown in FIG. 18, could leverage this information (for example some seconds or some milliseconds) in advance of its approach to 01.514, while 9032.1 may itself still be upon 1130 and may for example while being upon 1130, may not have the line-of-sight, or may not have field-of-view, or may not have the range-of-perception-sensing of some portions upon 1030 (and some transient-obstacles of any type therein), through its own on-board vision-perception sensors such as any 600-90 located upon or within itself.

In some cases, any type of 9032, such as 9032.1 for example, could directly leverage the position-location coordinates pertaining to the whole of the perception-coverage region within the set of perception zones, and accordingly determine a change to its speed profile in advance. As the case may be, any connected-autonomous vehicles could leverage this data; as a perception redundancy to their on-board vision-perception sensors, or as a guidance in advance of approach towards the pre-determined physical space, or, as the case may be, in some embodiments, this data could serve as an instruction or a priority-order relating to right-of-use or right-of-passage, in relation the pre-determined physical space.

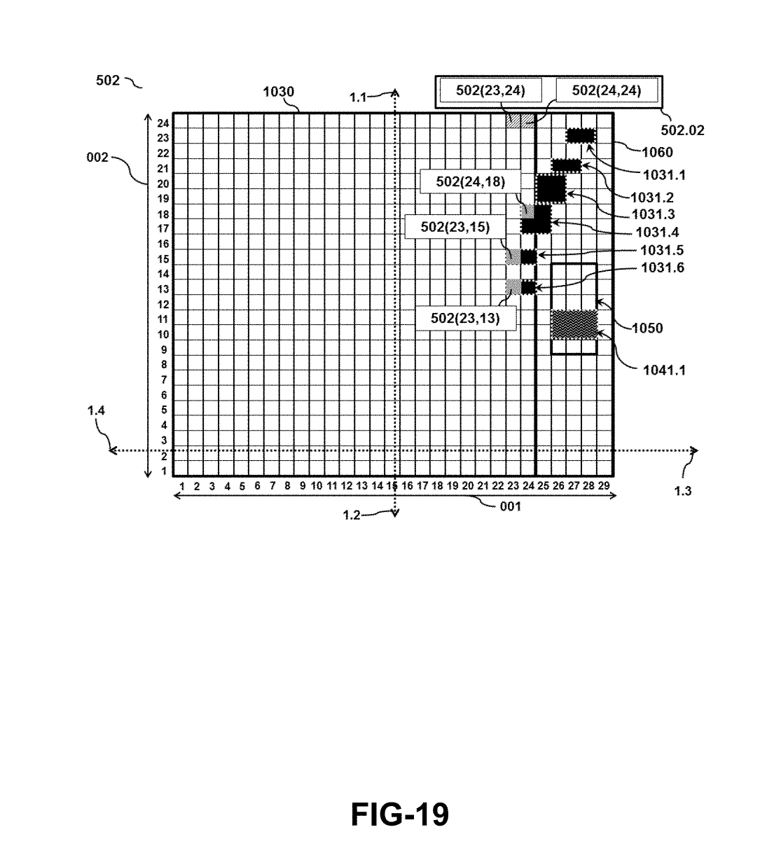

Reference is now made to FIG. 19 which is being referenced to show how in some embodiments, another type of perception-based advance guidance could be derived from, the position-location coordinates of the occupancy positions of any of any transient, static obstacles.

As shown in FIG. 10 before, during the referenced window of time therein referenced in FIG. 10, three of the transient, static obstacles; 1031.4, 1031.5 and 1031.6 are upon 1030. As the case be, 1030 may be for the use of vehicular traffic such as cars, and the transient, static obstacles could have been placed as a result of some emergent road works and therein any three-dimensional maps that are commonly utilised by connected-autonomous vehicles may not have updated data reflecting the occurrence of road works. Then based on knowledge (within the system of the invention) of the position-location coordinates of the occupancy positions of; 1031.4, 1031.5 and 1031.6, as upon 1030, a (virtual) blockade with respect to the perception zone could be represented, through determining the position-location coordinates of some portions of 502 to serve as the (virtual) blockade.

As shown in FIG. 19, which shows the two-dimensional, grid representation of 502 (also shown earlier with reference to FIG. 10), the position-location coordinates as given by the coordinate-labels; 502(23,24) and 502(24,24) could be determined as (virtual) blockades for entry into 502 (if entering 502 along the first orientation-axis; from the 1.1 towards the direction 1.2. In some embodiments, the blockade given by the coordinate-labels; 502(23,24) and 502(24,24) could be determined on the basis of the relevant position-location coordinates of the occupancy positions, for example, of; 1031.4, 1031.5 and 1031.6, as upon 1030. As shown in FIG. 19, in some embodiments, these relevant position-locations coordinates could be as given by the coordinate-labels; 502(23,13) relating to the occupancy position within 502 and upon 1030 of 1031.6, and 502(23,15) relating to the occupancy position within 502 and upon 1030 of 1031.5, and also 502(24,18) relating to the occupancy position within 502 and upon 1030 of 1031.4. Accordingly, in some embodiments, the ‘x’ coordinate values of all of the relevant position-location coordinates, could form the basis of determining the (virtual) blockade. For example, as can be appreciated that the ‘x’ coordinate value, of two of the relevant position-location coordinates given by the coordinate-labels; 502(23,13) and 502(23,15) is ‘23’. Also, it can be appreciated that the ‘x’ coordinate value, of the one other relevant position-location coordinate given by the coordinate-label 502(24,18), is ‘24’. Therefore, along the dimension 001 of 502 along which, the coordinate values of various grid-squares are expressed through the ‘x’ coordinate value, therein the grid-square positions ‘23’ and ‘24’, along 001, could serve as an effective (virtual) blockade. If it were then determined that the (virtual) blockade would be determined at the position-location of the last row of grid-squares (represented through the ‘y’ coordinate value ‘24’), then accordingly, the position-location coordinates of the determined (virtual) blockade would be, as shown in FIG. 19, and could be expressed through the coordinate-labels pertaining to the (virtual) blockade; 502(23,24) and 502(24,24). In some embodiments, if the position-location of perception zone, or of the pre-determined physical space is itself represented as an annotation within any type of three-dimensional or two-dimensional (localisation) map being used by any connected-autonomous vehicle, then therein, the connected-autonomous vehicles being able to localise itself within the three-dimensional or two-dimensional (localisation) map and could thereby, have available to itself, this information, (pertaining to the (virtual) blockade being determined as a result of any emergent roadworks while the three-dimensional maps have not been updated to reflect the occurrence of the emergent roadworks) as having been expressed within its localisation context (localisation context meaning; being localised within the context of the three-dimensional or two-dimensional map) as a form of ‘live’ map update, being available locally, when in proximity to the pre-determined physical space, being provisioned to it through the system of the invention. Alternatively, any map providers (providing three-dimensional localisation maps for autonomous driving) may similarly utilise the information (from the system of the invention) and effect a temporary update to the three-dimensional or two-dimensional (localisation) maps that they have created to serve the connected-autonomous vehicles and therein incorporate the information pertaining to the (virtual) blockade in relation to the pre-determined physical space or the given perception zone.

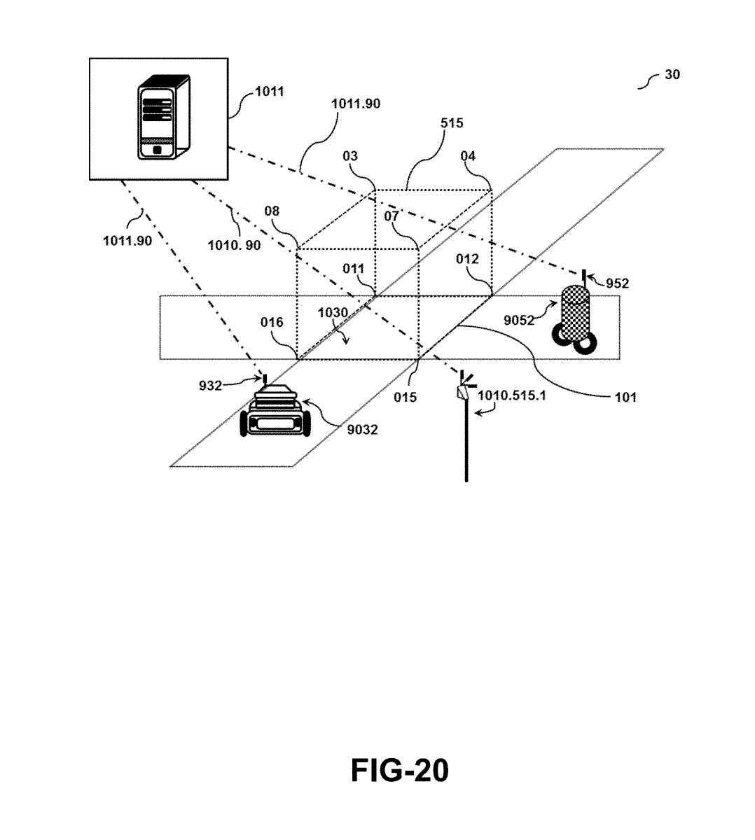

Reference is now made to FIG. 20 which shows a pre-determined physical space 101, and 101 as shown may be a junction of two road segments, within a geographic zone that is herein shown as being referenced through the label 30. A perception zone 515 is shown to have been established upon the exact footprint of 101 and would accordingly cover as shown, 1030 within 515 and upon 101 at the junction of two road segments. 515 is shown as being bounded within the eight corner points labelled; 08, 03, 04, 07, 016, 011, 012 and 015 and accordingly 1030 is shown bounded within the four corner points labelled; 016, 011, 012 and 015. A perception mast 1010.515.1 is shown to be operative for 515.

As shown, 9032 and 9052 may be two connected-autonomous vehicles of different types, and as shown 9032 and 9052 may be approaching 515 from different directions. As shown in FIG. 20, 952 upon 9052, may be any type of, 603-90 and 603-90 being as described with reference to FIG. 5 as well. Also, 932 upon 9032, may be any type of a 603-90 and 603-90 being as described with reference to FIG. 5. Alternatively, 952 and/or 932 may be any type of 601-90 and 601-90 being as described with reference to FIG. 5. Accordingly, 9052 or 9032 may be able to send and receive information to and from a central server such as 1011 at any given particular instance of time. Similarly, 1010.515.1 may be able to send and receive information to and from 1011 at any given particular instance of time. Thus any 1010.90 could be communicated from any perception mast such as 1010.515.1 to 1011 and; thereon may be transmitted by 1011 to any 9052 or to any 9032.

As shown in FIG. 20, the label 1010.90 is being used to depict, the provisioning of a perception-based notification file; 1010.90 pertaining to 515, from 1010.515.1 to 1011, and therein the provisioning of 1010.90 being for any number of 9032 and/or any number of 9052. As shown in FIG. 20, the label 1011.90 is being used to depict, the onward transmission by 1011, of the provisioned perception-based notification file; 1010.90 pertaining to 515, via any device or system mediation to, any number of 9032 and/or any number of 9052.

In some embodiments, based on the geolocation-location coordinates of 9032 and 9052, being received by 1011 from 9032 and 9052, and also accounting for any free-space within 515 as being determined by 1010.515.1, it may be determined, that an entry face of 515 may be declared as being (virtually) blocked for 9032, to first enable 9052 to enter and pass through 515. For example a virtual, planar-boundary of 515, being the entry face of 515 bounded by four corner points labelled; 07, 04, 012 and 015, may be declared as being (virtually) blocked for 9052 during a given window of time and after 9032 may have been detected by 1010.515.1 as having entered and then having passed through 515, the virtual, planar-boundary of 515 that had been declared as being (virtually) blocked for 9052 may thereafter, during a subsequent window of time, be declared as being open and accessible for 9052 to enter 515.

In some embodiments, a (virtual) blockade of an entry face would be determined on the basis of pre-determined priority with respect to any right-of-use being assigned to any specific type of a connected-autonomous vehicle, or due to any other factors pertaining to regulating the flow of autonomous traffic, the system of the invention therein operating as a type of virtual traffic signal for traffic comprising; connected-autonomous vehicles, manually driven connected-vehicles, as well as any types of vehicles that have connectivity as well as some automated driving features that may be operative from time to time interspersed with manual driving. Similarly, around blind corners, in the context of connected-autonomous vehicles approaching a ‘blind-corner’ from opposite sides could be directed to stop and wait till one of them has been permitted to pass through, and this could be similarly achieved through bringing into effect the same type of (virtual) blockade of an entry face of a perception zone established to have perception coverage upon a pre-determined physical space corresponding to the ‘blind-corner’.

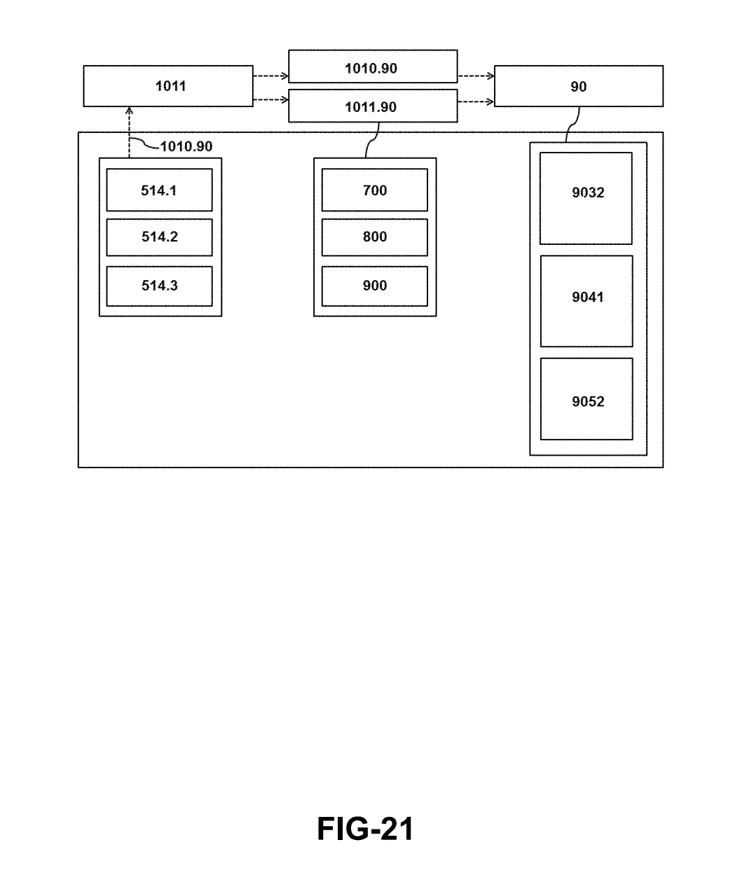

Reference is now made to FIG. 21 and also reference is concurrently made to FIG. 17 as well. It is herein described with reference to FIG. 21, that, any number of perception-based notification files 1010.90, (which may be pertaining to any number of any perception zones, such as for example, the set of perception zones, comprising; 514.1, 514.2 and 514.3, as described with reference to FIG. 17) being based on any of the perception outputs being determined through any or all of the operative perception masts; 1010.514.1, 1010.514.2 and 1010.514.3, thereby, in relation to the whole of, the set of perception zones, comprising; 514.1, 514.2 and 514.3, in some embodiments, any 1010.90 could be provisioned for any number of connected-autonomous vehicles, via a central server 1011 (such as 1011 referenced in FIG. 20). Accordingly in these embodiments, thereon, 1011 could onward transmit the any number of 1010.90 to the any number of connected-autonomous vehicles such as any; 9032, 9052 and 9041, further via any device or system mediation.

Additionally in some other embodiments, 1011 could aggregate additional geo-location coordinates of any; 9032, 9052 and 9041 as well as accounting for all (or some) aggregated 1010.90 pertaining to; 514.1, 514.2 and 514.3, a set of 1011.90 could be created as any further number of perception-based notification files, also being derived on the basis of any of, the perception outputs 200 (and specifically any position-location coordinates therein) that are found encoded within any 1010.90 available to 1011.

Accordingly, in some embodiments, 1011.90 would comprise, additionally, notification categories labelled; 700, 800 and 900 (which are referenced in FIG. 21). Herein, 700, in some embodiments would be pertaining to any viable or un-viable entry points from among a set of potential entry points into any perception zone. Also, 800, in some embodiments would be pertaining to any determined (virtual) blockade in the form of any position-location coordinates relating to any perception zone or relating to any pre-determined physical space. Lastly, 900, in some embodiments, would be pertaining to any determined (virtual) blockade of any entry face, relating to any perception zone. Thus in some embodiments, 1011 could, onward transmit, additionally to any 1010.90, any number of perception-based notification files; 1011.90 for any number of connected-autonomous vehicles; 9032, 9052 and 9041, via any device or system mediation. Herein, a system intermediation could also mean that any 1011.90 may be transmitted to any 1010 within the system of the invention for onward transmission to any other 1010 or to any connected-autonomous vehicle such as any; 9032, 9052 and 9041.

### CONCLUSIONS

Preferred embodiments and specific examples thereof have been disclosed for the purpose of illustration and teaching, however it will be readily apparent to those of ordinary skill in the art that other embodiments and examples may be possible through combining the system and methods differently. All such equivalent embodiments, examples and combinations are within the spirit and scope of the present invention, and may be comprised within the scope and the spirit of the following claims, or may be comprised within the scope and the spirit of any amended claims:

1. A system for augmenting the performance of on-board capabilities, of any automated driving system of a connected-autonomous vehicle, the system comprising:
acquiring any perception outputs, from, a plurality of vision-perception sensors, wherein at least one of, the plurality of vision-perception sensors, is not on-board the connected-autonomous vehicle, and the any perception outputs, pertain to, a detection, of any transient, obstacle being in any state of motion or being static, as detected, by any one or more of, the plurality of vision-perception sensors;
representing, the detection, within one or more grid occupancy maps;
provisioning, the detection, as represented within the one or more grid occupancy maps, for sharing among, the plurality of vision-perception sensors and a plurality of connected-autonomous vehicles, in a shared coordinate-frame.

2. A system of claim 1, wherein the any perception outputs, also pertain to a detection of any free-space.

3. A system of claim 1, wherein one of, the plurality of vision-perception sensors, is mounted upon or contained within a perception mast.

4. A system of claim 3, wherein the perception mast may additionally comprise:
a global positioning system device, determining the precise geo-locations of the vision-perception sensor, that is mounted upon or contained within the perception mast; and,
a machine-vision processor, being operably connected to the vision-perception sensor, and the machine-vision processor therein performing any number of processing tasks for processing, any un-processed outputs being produced by the vision-perception sensor; and,
a computer memory device of any type, being operably connected to the machine-vision processor and to the vision-perception sensor, and the computer memory device, therein storing, the any un-processed outputs being produced by the vision-perception sensor, as well as storing any processed outputs being produced by the machine-vision processor; and,
a roadside unit DSRC beacon or any other transceiver, being operably connected to the computer memory device of any type, and the therein transmitting any of the stored data being stored within the computer memory device of any type to any connected-autonomous vehicle either directly; through the transceiver or through the roadside unit DSRC beacon, or, through the system-mediation of any intelligent transport system.

5. A system of claim 3, wherein circumscribing, any part of a physical space that is covered within a field-of-view of the any vision-perception sensor that is mounted upon or contained within a perception mast, as a pre-determined physical space.

6. A system of claim 5, wherein establishing, a perception-coverage region, corresponding to the pre-determined physical space, and herein, the perception-coverage region would be established as being either, a two-dimensional, perception-coverage region, or, a three-dimensional, perception-coverage region.

7. A system of claim 6, wherein a combined perception output is created for the perception-coverage region by stitching together, the any perception outputs from any two or more of, the plurality of vision-perception sensors, when the said any two or more of, the plurality of vision-perception sensors may be having an overlapping view of the perception-coverage region.

8. A system of claim 6, wherein a combined detection is created for the perception-coverage region by fusing, any detections pertaining to the same transient, obstacle, herein the any detections being from any two or more of, the plurality of vision-perception sensors, when the said any two or more of, the plurality of vision-perception sensors may be having an overlapping view of the perception-coverage region.

9. A system of claim 6, wherein configuring, a data representation scheme, for, representing the detection, as being a detection in the context of the perception-coverage region, and thereby being represented as a grid occupancy map, and further herein, the dimensionality of the data representation scheme, being according to the dimensionality of the perception-coverage region.

10. A system of claim 9, wherein the data representation scheme assigns a unique identity label to, each of the various position-locations, within the grid occupancy map.

11. A system of claim 10, wherein, the unique identity label is assigned to a grid-square, in the case of a two-dimensional data representation scheme wherein the grid-square being the smallest measurement unit, whereas, in the case of a three-dimensional data representation scheme, the unique identity label is assigned to a smaller-cuboid wherein the smaller-cuboid being the smallest measurement unit.

12. A system of claim 9, wherein the data representation scheme assigns a unique coordinate-label, to each of the various position-locations within the grid occupancy map.

13. A system of claim 12, wherein, wherein, the unique coordinate-label is assigned to a grid-square, in the case of a two-dimensional data representation scheme wherein the grid-square being the smallest measurement unit, whereas, in the case of a three-dimensional data representation scheme, the unique coordinate-label is assigned to a smaller-cuboid wherein the smaller-cuboid being the smallest measurement unit.

14. A system of claim 9, wherein choosing, any level of resolution of data representation, within the configured, data representation scheme, for expressing, various discrete position-locations of the perception-coverage region, within the grid occupancy map.

15. A system of claim 14, wherein a perception-based notification file, pertaining to the perception-coverage region, is created, therein encoding any of the detections being expressed as per the data representation scheme.

16. A system of claim 15, wherein the perception-based notification file may be transmitted through any means or mediation, to a central server, for onward communication to any vision-perception sensor.

17. A system of claim 15, wherein the perception-based notification file may be transmitted through any means or mediation, to a central server, for onward communication to any connected-autonomous vehicle.

18. A system of claim 17, wherein the central server undertakes any processing tasks so as to include within the perception-based notification file, any instruction or guidance, for any one or more connected-autonomous vehicles.

19. A system of claim 18, wherein the instruction or guidance may be a navigational guidance, in response to the situational context of any transient, obstacles within the perception-coverage region.

20. A system of claim 18, wherein the instruction or guidance may be a right-of-way determination in relation to the perception-coverage region, and be implemented by way of assigning a priority to any one, among two or more, connected-vehicles.

21. A system of claim 18, wherein the instruction or guidance may be a right-of-stopping determination, implemented by way of conveying any indication of availability, of any designated parking spot or of any designated landing spot, within the perception-coverage region.

22. A system of claim 18, wherein the instruction or guidance may be a right-of-use determination, implemented by assigning, any right-of-passage for passing through the perception-coverage region or assigning any right-of-entry for entering into the perception-coverage region.

23. A system of claim 18, wherein the instruction or guidance may be an assigned determination, implemented by conveying, any viable entry points or any un-viable entry points, wherein, the any viable entry points or any un-viable entry points being in relation to entering any portion of the perception-coverage region.

24. A system of claim 18, wherein the instruction or guidance may be an assigned determination, implemented by conveying, any blocked portion, of the perception-coverage region, herein, the any blocked portion, being declared as having been blocked, due to the situation of any transient, static obstacle within the perception-coverage region.

25. A system of claim 18, wherein the instruction or guidance may be an assigned determination, implemented by conveying, any blocked entry face of the perception-coverage region, herein the any blocked entry face, being declared as having been blocked wherein the perception-coverage region may be upon a junction of two roads.

26. A method for augmenting the performance of on-board capabilities, of any automated driving system of a connected-autonomous vehicle, the method comprising the steps of:
acquiring any perception outputs, from, a plurality of vision-perception sensors, wherein at least one of, the plurality of vision-perception sensors, is not on-board the connected-autonomous vehicle, and the any perception outputs, pertain to, a detection, of any transient, obstacle being in any state of motion or being static, as detected, by any one or more of, the plurality of vision-perception sensors;
representing, the detection, within one or more grid occupancy maps;
provisioning, the detection, as represented within the one or more grid occupancy maps, for sharing among, the plurality of vision-perception sensors and a plurality of connected-autonomous vehicles, in a shared coordinate-frame.

27. A method of claim 26, wherein the any perception outputs, also pertain to a detection of any free-space.

28. A method of claim 26, wherein mounting, one of, the plurality of vision-perception sensors, upon or within, a perception mast.

29. A method of claim 28, wherein;
mounting, a global positioning system device, upon or within the perception mast, and using the global positioning system for determining the precise geo-locations of the vision-perception sensor, that is mounted upon or within the perception mast;
mounting, a machine-vision processor, upon or within the perception mast, and operably connecting the machine-vision processor to the vision-perception sensor, and using the machine-vision processor to process, any un-processed outputs being produced by the vision-perception sensor;
operably connecting, a computer memory device of any type, to the vision-perception sensor and to the machine-vision processor, and using the computer memory device of any type, for therein storing, any of the un-processed outputs being produced by the vision-perception sensor and any of the processed outputs being produced by the machine-vision processor;
operably connecting, a roadside unit DSRC beacon or any other transceiver, to the computer memory device of any type, and thereby transmitting any of the stored data, to any connected-autonomous vehicle, either directly; through the transceiver or the roadside unit DSRC beacon, or, through the system-mediation of any intelligent transport system.

30. A method of claim 28, wherein circumscribing, any part of a physical space that is covered within a field-of-view of the any vision-perception sensor that is mounted upon or contained within a perception mast, as a pre-determined physical space.

31. A method of claim 30, wherein establishing, a perception-coverage region, corresponding to the pre-determined physical space, and herein, the perception-coverage region would be established as being either, a two-dimensional, perception-coverage region, or, a three-dimensional, perception-coverage region.

32. A method of claim 31, wherein a combined perception output is created for the perception-coverage region by stitching together, the any perception outputs from any two or more of, the plurality of vision-perception sensors, when the said any two or more of, the plurality of vision-perception sensors may be having an overlapping view of the perception-coverage region.

33. A method of claim 31, wherein a combined detection is created for the perception-coverage region by fusing, any detections pertaining to the same transient, obstacle, herein the any detections being from any two or more of, the plurality of vision-perception sensors, when the said any two or more of, the plurality of vision-perception sensors may be having an overlapping view of the perception-coverage region.

34. A method of claim 31, wherein configuring, a data representation scheme, for, representing the detection, as being a detection in the context of the perception-coverage region, and thereby being represented as a grid occupancy map, and further herein, the dimensionality of the data representation scheme, being according to the dimensionality of the perception-coverage region.

35. A method of claim 34, wherein the data representation scheme assigns a unique identity label to, each of the various position-locations, within the grid occupancy map.

36. A method of claim 35, wherein, the unique identity label is assigned to a grid-square, in the case of a two-dimensional data representation scheme wherein the grid-square being the smallest measurement unit, whereas, in the case of a three-dimensional data representation scheme, the unique identity label is assigned to a smaller-cuboid wherein the smaller-cuboid being the smallest measurement unit.

37. A method of claim 34, wherein the data representation scheme assigns a unique coordinate-label, to each of the various position-locations within the grid occupancy map.

38. A method of claim 37, wherein, wherein, the unique coordinate-label is assigned to a grid-square, in the case of a two-dimensional data representation scheme wherein the grid-square being the smallest measurement unit, whereas, in the case of a three-dimensional data representation scheme, the unique coordinate-label is assigned to a smaller-cuboid wherein the smaller-cuboid being the smallest measurement unit.

39. A method of claim 34, wherein choosing, any level of resolution of data representation, within the configured, data representation scheme, for expressing, various discrete position-locations of the perception-coverage region, within the grid occupancy map.

40. A method of claim 39, wherein a perception-based notification file, pertaining to the perception-coverage region, is created, therein encoding any of the detections being expressed as per the data representation scheme.

41. A method of claim 40, wherein the perception-based notification file may be transmitted through any means or mediation, to a central server, for onward communication to any vision-perception sensor.

42. A method of claim 40, wherein the perception-based notification file may be transmitted through any means or mediation, to a central server, for onward communication to any connected-autonomous vehicle.

43. A method of claim 42, wherein the central server undertakes any processing tasks so as to include within the perception-based notification file, any instruction or guidance, for any one or more connected-autonomous vehicles.

44. A method of claim 43, wherein the instruction or guidance may be a navigational guidance, in response to the situational context of any transient, obstacles within the perception-coverage region.

45. A method of claim 43, wherein the instruction or guidance may be a right-of-way determination in relation to the perception-coverage region, and be implemented by way of assigning a priority to any one, among two or more, connected-vehicles.

46. A method of claim 43, wherein the instruction or guidance may be a right-of-stopping determination, implemented by way of conveying any indication of availability, of any designated parking spot or of any designated landing spot, within the perception-coverage region.

47. A method of claim 43, wherein the instruction or guidance may be a right-of-use determination, implemented by assigning, any right-of-passage for passing through the perception-coverage region or assigning any right-of-entry for entering into the perception-coverage region.

48. A method of claim 43, wherein the instruction or guidance may be an assigned determination, implemented by conveying, any viable entry points or any un-viable entry points, wherein, the any viable entry points or any un-viable entry points being in relation to entering any portion of the perception-coverage region.

49. A method of claim 43, wherein the instruction or guidance may be an assigned determination, implemented by conveying, any blocked portion, of the perception-coverage region, herein, the any blocked portion, being declared as having been blocked, due to the situation of any transient, static obstacle within the perception-coverage region.

50. A method of claim 43, wherein the instruction or guidance may be an assigned determination, implemented by conveying, any blocked entry face of the perception-coverage region, herein the any blocked entry face, being declared as having been blocked wherein the perception-coverage region may be upon a junction of two roads.
